(19) United States
(12) Patent Application Publication
(10) Pub. No.: US 2020/0313228 A1
(43) Pub. Date: Oct. 1, 2020

(54) Positive Electrode Active Material Particle and Method for Manufacturing Positive Electrode Active Material Particle

(71) Applicant: SEMICONDUCTOR ENERGY LABORATORY CO., LTD., ATSUGI-SHI (JP)

(72) Inventors: Teruaki OCHIAI, Atsugi (JP); Takahiro KAWAKAMI, Atsugi (JP); Mayumi MIKAMI, Atsugi (JP); Yohei MOMMA, Isehara (JP); Ayae TSURUTA, Atsugi (JP); Masahiro TAKAHASHI, Atsugi (JP)

(73) Assignee: SEMICONDUCTOR ENERGY LABORATORY CO., LTD., ATSUGI-SHI (JP)

(21) Appl. No.: 16/901,121

(22) Filed: Jun. 15, 2020

Related U.S. Application Data
(62) Division of application No. 15/810,989, filed on Nov. 13, 2017.

(30) Foreign Application Priority Data
Nov. 24, 2016 (JP) 2016-227494

(51) Int. Cl. H01M 10/0525; H01M 4/505; H01M 4/485; H01M 4/02; H01M 4/525

(52) U.S. Cl. CPC H01M 10/0525; H01M 4/505; H01M 4/485; H01M 4/366; H01M 4/525; Y02E 60/13; H01M 4/02

(57) ABSTRACT

Positive electrode active material particles that inhibit a decrease in capacity due to charge and discharge cycles are provided. A high-capacity secondary battery, a secondary battery with excellent charge and discharge characteristics, or a highly-safe or highly-reliable secondary battery is provided. A novel material, active material particles, and a storage device are provided. The positive electrode active material particle includes a first region and a second region in contact with the outside of the first region. The first region contains lithium, oxygen, and an element M that is one or more elements selected from cobalt, manganese, and nickel. The second region contains the element M, oxygen, magnesium, and fluorine. The atomic ratio of lithium to the element M (Li/M) measured by X-ray photoelectron spectroscopy is 0.5 or more and 0.85 or less. The atomic ratio of magnesium to the element M (Mg/M) is 0.2 or more and 0.5 or less.

### CROSS-REFERENCE TO RELATED APPLICATIONS

This application is a divisional of U.S. application Ser. No. 15/810,989, filed Nov. 13, 2017, now pending, which claims the benefit of a foreign priority application filed in Japan as Serial No. 2016-227494 on Nov. 24, 2016, both of which are incorporated by reference.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof. One embodiment of the present invention relates to an electronic device and an operating system thereof.

In this specification, the power storage device is a collective term describing units and devices having a power storage function. For example, a storage battery (also referred to as secondary battery) such as a lithium-ion secondary battery, a lithium-ion capacitor, and an electric double layer capacitor are included in the category of the power storage device.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, and air batteries have been actively developed. In particular, a demand for lithium-ion secondary batteries with high output and high capacity has rapidly grown with the development of the semiconductor industry, for portable information terminals such as mobile phones, smartphones, and laptop computers, portable music players, and digital cameras; medical equipment; next-generation clean energy vehicles such as hybrid electric vehicles (HEV), electric vehicles (EV), and plug-in hybrid electric vehicles (PHEV); and the like. The lithium-ion secondary batteries are essential as rechargeable energy supply sources for today's information society.

The performance currently required for lithium-ion secondary batteries includes increased capacity, improved cycle performance, safe operation under a variety of environments, and longer-term reliability.

Thus, improvement of a positive electrode active material has been studied to increase the cycle performance and the capacity of lithium-ion secondary batteries (Patent Document 1 and Patent Document 2).

### Patent Document

[Patent Document 1] Japanese Published Patent Application No. 2012-018914
[Patent Document 2] Japanese Published Patent Application No. 2016-076454

### SUMMARY OF THE INVENTION

That is, development of lithium-ion secondary batteries and positive electrode active materials used therein is susceptible to improvement in terms of capacity, cycle performance, charge and discharge characteristics, reliability, safety, cost, and the like.

An object of one embodiment of the present invention is to provide positive electrode active material particles which inhibit a decrease in capacity due to charge and discharge cycles when used in a lithium-ion secondary battery. Another object of one embodiment of the present invention is to provide high-capacity secondary batteries. Another object of one embodiment of the present invention is to provide secondary batteries with excellent charge and discharge characteristics. Another object of one embodiment of the present invention is to provide highly safe or highly reliable secondary batteries.

Another object of one embodiment of the present invention is to provide novel materials, novel active material particles, novel storage devices, or a manufacturing method thereof.

Note that the description of these objects does not disturb the existence of other objects. In one embodiment of the present invention, there is no need to achieve all the objects. Other objects can be derived from the description of the specification, the drawings, and the claims.

One embodiment of the present invention is a positive electrode active material particle including a first region and a second region. The second region includes a region in contact with the outside of the first region. The first region contains lithium, an element M, and oxygen. The element M is one or more elements selected from cobalt, manganese, and nickel. The second region contains the element M, oxygen, magnesium, and fluorine. The atomic ratio of lithium to the element M (Li/M) measured by X-ray photoelectron spectroscopy is higher than or equal to 0.5 and lower than or equal to 0.85. The atomic ratio of magnesium to the element M (Mg/M) measured by X-ray photoelectron spectroscopy is higher than or equal to 0.2 and lower than or equal to 0.5. X-ray photoelectron spectroscopy analysis is performed on the surface of the positive electrode active material particle, for example.

In the above structure, the thickness of the second region is preferably greater than or equal to 0.5 nm and less than or equal to 50 nm.

In the above structure, it is preferred that the first region have a layered rock-salt crystal structure and the second region have a rock-salt crystal structure.

In the above structure, it is preferred that the crystal structure of the first region be represented by a space group R-3m and the crystal structure of the second region be represented by a space group Fm-3m.

In the above structure, the atomic ratio of the fluorine to the element M (F/M) measured by X-ray photoelectron spectroscopy is preferably higher than or equal to 0.02 and lower than or equal to 0.15.

In the above structure, the element M is preferably cobalt.

Another embodiment of the present invention is a positive electrode active material particle including a first region and a second region. The second region includes a region in contact with the outside of the first region. The first region contains lithium, an element M, and oxygen. The element M is one or more elements selected from cobalt, manganese, and nickel. The second region contains the element M, oxygen, magnesium, and fluorine. The particle is formed using a plurality of raw materials. The ratio of the total number of lithium atoms in the plurality of raw materials to the total number of element M atoms in the plurality of raw materials (Li/M) is higher than 1.02 and lower than 1.05.

In the above structure, the ratio of the number of magnesium atoms in the plurality of raw materials to the total number of element M atoms in the plurality of raw materials is preferably higher than or equal to 0.005 and lower than or equal to 0.05.

In the above structure, the ratio of the number of fluorine atoms in the plurality of raw materials to the total number of element M atoms in the plurality of raw materials is preferably higher than or equal to 0.01 and lower than or equal to 0.1.

In the above structure, it is preferred that one of the plurality of raw materials be a compound containing the element M, another of the plurality of raw materials be a compound containing lithium, and another of the plurality of raw materials be a compound containing magnesium.

In the above structure, the thickness of the second region is preferably greater than or equal to 0.5 nm and less than or equal to 50 nm.

According to one embodiment of the present invention, a positive electrode active material which inhibits a reduction in capacity due to charge and discharge cycles when used in a lithium-ion secondary battery can be provided. A lithium secondary battery with high capacity can be provided. A secondary battery with excellent charge and discharge characteristics can be provided. A highly safe or highly reliable secondary battery can be provided. A novel material, novel active material particles, a novel storage device, or a manufacturing method thereof can be provided.

### BRIEF DESCRIPTION OF THE DRAWINGS

FIGS. 1A to 1C illustrate examples of positive electrode active material particles.

FIG. 2 shows an example of a manufacturing method of positive electrode active material particles.

FIGS. 3A and 3B are cross-sectional views of an active material layer containing a graphene compound as a conductive additive.

FIGS. 4A and 4B illustrate a coin-type secondary battery.

FIGS. 5A and 5B illustrate a cylindrical secondary battery.

FIGS. 6A and 6B illustrate an example of a power storage device.

FIGS. 7A1, 7A2, 7B1, and 7B2 illustrate examples of power storage devices.

FIGS. 8A and 8B illustrate examples of power storage devices.

FIGS. 9A and 9B illustrate examples of power storage devices.

FIG. 10 illustrates an example of a power storage device.

FIGS. 11A to 11C illustrate a laminated secondary battery.

FIGS. 12A and 12B illustrate a laminated secondary battery.

FIG. 13 is an external view of a secondary battery.

FIG. 14 is an external view of a secondary battery.

FIGS. 15A to 15C illustrate a manufacturing method of a secondary battery.

FIGS. 16A, 16B1, 16B2, 16C, and 16D illustrate a bendable secondary battery.

FIGS. 17A and 17B illustrate a bendable secondary battery.

FIGS. 18A to 18H illustrate examples of electronic devices.

FIGS. 19A to 19C illustrate an example of an electronic device.

FIG. 20 illustrates examples of electronic devices.

FIGS. 21A to 21C illustrate examples of electronic devices.

FIGS. 22A and 22B show SEM observation results.

FIGS. 23A and 23B show SEM observation results.

FIGS. 24A and 24B show SEM observation results.

FIGS. 25A and 25B show measurement results of particle size distribution.

FIG. 26 shows measurement results of particle size distribution.

FIG. 27 shows XPS measurement results.

FIG. 28 shows XPS measurement results.

FIG. 29 shows XPS measurement results.

FIGS. 30A and 30B show HAADF-STEM images.

FIGS. 31A and 31B are graphs showing the energy density retention rates of secondary batteries.

### DETAILED DESCRIPTION OF THE INVENTION

Embodiments and examples of the present invention will be described below in detail with reference to the accompanying drawings. Note that the present invention is not limited to the description below, and it is easily understood by those skilled in the art that modes and details of the present invention can be modified in various ways. In addition, the present invention should not be construed as being limited to the description in the embodiments and examples given below.

In the crystallography, a bar is placed over a number in the expression of crystal planes and orientations; however, in this specification and the like, crystal planes and orientations are expressed by placing a minus sign (−) at the front of a number instead of placing the bar over a number because of limitation on the expression in the application. Furthermore, an individual direction which shows an orientation in crystal is denoted by “[ ]”, a set direction which shows all of the equivalent orientations is denoted by “< >”, an individual direction which shows a crystal plane is denoted by “( )”, and a set plane having equivalent symmetry is denoted by “{ }”.

In this specification and the like, segregation refers to a phenomenon in which in a solid made of a plurality of elements (e.g., A, B, and C), a certain element (e.g., B) is non-uniformly distributed.

In this specification and the like, a layered rock-salt crystal structure included in complex oxide containing lithium and a transition metal refers to a crystal structure in which a rock-salt ion arrangement where cations and anions are alternately arranged is included and the lithium and the transition metal are regularly arranged to form a two-dimensional plane, so that lithium can be two-dimensionally diffused. Note that a defect such as a cation or anion vacancy can exist.

Furthermore, in this specification and the like, a state where the structures of two-dimensional interfaces have similarity is referred to as “epitaxy”. Crystal growth in which the structures of two-dimensional interfaces have similarity is referred to as “epitaxial growth”. In addition, a state where three-dimensional structures have similarity or orientations are crystallographically the same is referred to as “topotaxy”. Thus, in the case of topotaxy, when part of a cross section is observed, the orientations of crystals in two regions (e.g., a region serving as a base and a region formed through growth) are aligned with each other.

A rock-salt crystal structure refers to a structure in which cations and anions are alternately arranged. Note that a cation or anion vacancy may exist.

Anions of a layered rock-salt crystal and anions of a rock-salt crystal each form a cubic closest packed structure (face-centered cubic lattice structure). When a layered rock-salt crystal and a rock-salt crystal are in contact with each other, there is a crystal plane at which cubic closest packed structures formed of anions coincide with each other. Note that a space group of the layered rock-salt crystal is R-3m, which is different from a space group Fm-3m of a rock-salt crystal; thus, the index of the crystal plane satisfying the above conditions in the layered rock-salt crystal is different from that in the rock-salt crystal. In this specification, in the layered rock-salt crystal and the rock-salt crystal, a state where the orientations of the crystal planes satisfying the above conditions are aligned with each other can be referred to as a state where crystal orientations are aligned with each other.

For example, when lithium cobalt oxide having a layered rock-salt crystal structure and magnesium oxide having a rock-salt crystal structure are in contact with each other, the orientations of crystals are aligned in the following cases: the (1-1-4) plane of lithium cobalt oxide is in contact with the {001} plane of magnesium oxide, the (104) plane of lithium cobalt oxide is in contact with the {001} plane of magnesium oxide, the (0-14) plane of lithium cobalt oxide is in contact with the {001} plane of the magnesium oxide, the (001) plane of lithium cobalt oxide is in contact with the {111} plane of magnesium oxide, the (012) plane of lithium cobalt oxide is in contact with the {111} plane of magnesium oxide, and the like.

Whether the crystal orientations in two regions are aligned with each other or not can be judged from a transmission electron microscope (TEM) image, a scanning transmission electron microscope (STEM) image, a high-angle annular dark field scanning transmission electron microscope (HAADF-STEM) image, an annular bright-field scan transmission electron microscope (ABF-STEM) image, and the like. X-ray diffraction (XRD), electron diffraction, neutron diffraction, and the like can be used for judging. When the crystal orientations are aligned with each other, a state where an angle between the orientations of lines in each of which cations and anions are alternately arranged is less than or equal to 5°, preferably less than or equal to 2.5° is observed from a TEM image and the like. Note that, in the TEM image and the like, a light element such as oxygen or fluorine is not clearly observed in some cases; however, in such a case, the alignment of orientations can be judged by the arrangement of metal elements.

A space group can be determined by analyzing its structure by X-ray diffraction, electron diffraction, or fast Fourier transform (FFT) of a STEM image and a TEM image, for example. For example, an FFT image of a STEM image is analyzed and compared with a database such as the ICDD (International Centre for Diffraction Data) database to identify the crystal structure.

### Embodiment 1

In this embodiment, positive electrode active material particles of one embodiment of the present invention will be described.

### [Structure of Positive Electrode Active Material]

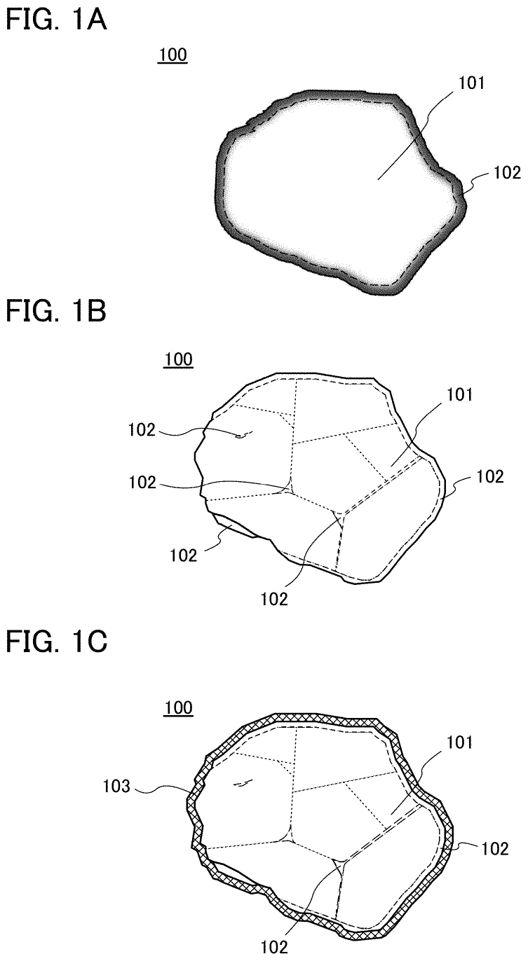

First, a positive electrode active material particle 100, which is one embodiment of the present invention, will be described with reference to FIGS. 1A to 1C. As shown in FIG. 1A, the positive electrode active material particle 100 includes a first region 101 and a second region 102 in contact with the outside of the first region 101. The second region 102 can cover at least part of the first region 101.

The second region 102 is preferably a layered region.

The first region 101 has composition different from that of the second region 102. Note that the boundary between the two regions is not clear in some cases. In FIG. 1A, the boundary between the first region 101 and the second region 102 is shown by the dotted line, and the concentration gradient of elements is shown with the contrast across the dotted line. In FIG. 1B and the following drawings, the boundary between the first region 101 and the second region 102 is shown only by the dotted lines for convenience. The details of the boundary between the first region 101 and the second region 102 will be described later.

As illustrated in FIG. 1B, the second region 102 may exist in an inner portion of the positive electrode active material particle 100. For example, in the case where the first region 101 is a polycrystal, segregation of the second region 102 may be observed in the grain boundary. Furthermore, segregation of the second region 102 may be observed in a portion which includes crystal defects in the positive electrode active material particle 100. Note that in this specification and the like, crystal defects refer to volume defects which can be observed with a TEM, or a structure in which another element enters the crystal, for example

The second region 102 does not necessarily cover the entire first region 101.

In other words, the first region 101 exists in the inner portion of the positive electrode active material particle 100, and the second region 102 exists in a superficial portion of the positive electrode active material particle 100. In addition, the second region 102 may exist in the inner portion of the positive electrode active material particle 100.

The first region 101 and the second region 102 can also be referred to as a solid phase A and a solid phase B, respectively, for example

### <First Region 101>

The first region 101 contains lithium, an element M, and oxygen. The element M may be a plurality of elements. The element M is one or more elements selected from transition metals, for example. The first region 101 contains a complex oxide containing lithium and a transition metal, for example.

As the element M, a transition metal that can form a layered rock-salt complex oxide with lithium is preferably used. For example, one or a plurality of manganese, cobalt, and nickel can be used. That is, as the transition metal contained in the first region 101, only cobalt may be used, cobalt and manganese may be used, or cobalt, manganese, and nickel may be used. In addition to the transition metal as the element M, the first region 101 may contain a metal other than the transition metal, such as aluminum.

In other words, the first region 101 can contain a complex oxide containing lithium and the transition metal, such as lithium cobalt oxide, lithium nickel oxide, lithium cobalt oxide in which manganese is substituted for part of cobalt, lithium nickel-manganese-cobalt oxide, or lithium nickel-cobalt-aluminum oxide.

A layered rock-salt crystal structure is preferred for the first region 101 because lithium is likely to be diffused two-dimensionally. In addition, when the first region 101 has a layered rock-salt crystal structure, segregation of magnesium oxide, which will be described later, tends to occur unexpectedly. Note that the entire first region 101 does not necessarily have a layered rock-salt crystal structure. For example, part of the first region 101 may include crystal defects, may be amorphous, or may have another crystal structure.

The first region 101 may be represented by a space group R-3m.

### <Second Region 102>

The second region 102 contains the element M and oxygen. For example, the second region contains an oxide of the element M.

Furthermore, the second region preferably contains magnesium in addition to the element M and oxygen. Furthermore, the second region preferably contains fluorine. The second region preferably contains magnesium and fluorine, in which case the stability in charge and discharge of a secondary battery may be improved. Here, high stability of the secondary battery means that a change in the crystal structure of the positive electrode active material particle 100 is inhibited, a change in capacity is small, or a change in the valence of a transition metal contained in the second region 102, such as cobalt, is reduced, for example.

The second region 102 may contain magnesium oxide and part of the oxygen may be substituted by fluorine. Magnesium oxide is an electrochemically stable material that is less likely to deteriorate even when charge and discharge are repeated; thus, magnesium oxide is suitable for a coating layer.

Substitution of fluorine for part of magnesium oxide enhances diffusion of lithium, for example, so that charge and discharge are not prevented. Moreover, when fluorine exists in the vicinity of a superficial portion of the positive electrode active material, e.g., the second region 102, the positive electrode active material is not easily dissolved in hydrofluoric acid.

When the thickness of the second region 102 is too small, the function of a coating layer is degraded; however, when the thickness of the second region 102 is too large, the capacity is decreased. Thus, the thickness of the second region 102 is preferably greater than or equal to 0.5 nm and less than or equal to 50 nm, more preferably greater than or equal to 0.5 nm and less than or equal to 3 nm.

The thickness of the second region 102 can be measured by a TEM. For example, the positive electrode active material particle is processed so that its cross section is exposed, and then, observation is performed with a TEM.

The second region 102 preferably has a rock-salt crystal structure because the orientations of crystals are likely to be aligned with those in the first region 101, and thus the second region 102 easily functions as a stable coating layer. Note that the entire second region 102 does not necessarily have a rock-salt crystal structure. For example, part of the second region 102 may be amorphous or has another crystal structure.

The second region 102 may be represented by a space group Fm-3m.

In general, when charge and discharge are repeated, a side reaction occurs in the positive electrode active material particle 100, for example, a transition metal such as manganese or cobalt is dissolved in an electrolytic solution, oxygen is released, and the crystal structure becomes unstable, so that the positive electrode active material particle 100 deteriorates. However, the positive electrode active material particle 100 of one embodiment of the present invention includes the second region 102 in its superficial portion; thus, the crystal structure of the complex oxide containing lithium and the transition metal in the first region 101 can be more stable.

The relation between the second region to be formed and the atomic ratio of lithium to the element M in a manufacturing process of the positive electrode active material of one embodiment of the present invention will be described. In the manufacturing process, most of an excessive amount of element M is distributed on the surface of the positive electrode active material to form the second region. The atomic ratio of lithium to the element M (hereinafter referred to as Li/M) is set low, whereby an excessive amount of element M is generated and thus the second region can be formed.

The ratio of the element M to lithium in the second region is higher than that in the first region (that is, the Li/M in in the second region is lower than that in the first region). Alternatively, lithium is not detected in the second region, in some cases.

Meanwhile, increasing Li/M increases the average diameter of the positive electrode active material particles 100, in some cases. As the average particle diameter increases, the specific surface area decreases. The case where a side reaction such as the decomposition of an electrolytic solution occurs in a secondary battery will be described. In that case, decreasing the specific surface area of the active material particles reduces the area where the active material particles are in contact with the electrolytic solution, resulting in a reduction in the amount of such a side reaction. Here, a side reaction refers to an irreversible reaction in charge and discharge of a secondary battery, for example.

It is preferred that the second region 102 also exist in the first region 101 as shown in FIG. 1B because the crystal structure of the complex oxide containing lithium and a transition metal in the first region 101 can be more stable.

In addition, fluorine contained in the second region 102 exists preferably in a bonding state other than MgF₂, LiF, and CoF₂. Specifically, when an X-ray photoelectron spectroscopy (XPS) analysis is performed on the surface of the positive electrode active material particle 100, a peak position of bonding energy with fluorine is preferably higher than or equal to 682 eV and lower than or equal to 685 eV, more preferably approximately 684.3 eV. The bonding energy does not correspond to those of MgF₂ and LiF.

In this specification and the like, a peak position of the bonding energy of an element in an XPS analysis refers to the value of bonding energy at which the maximal intensity of an energy spectrum is obtained in a range corresponding to the bonding energy of the element.

### <First Region 101 and Second Region 102>

The difference in composition between the first region 101 and the second region 102 can be observed using a TEM image, a STEM image, fast Fourier transform (FFT) analysis, energy dispersive X-ray spectrometry (EDX), an analysis in the depth direction by time-of-flight secondary ion mass spectrometry (ToF-SIMS), XPS, Auger electron spectroscopy, thermal desorption spectroscopy (TDS), or the like. For example, a difference between constituent elements is observed as a difference in brightness in a TEM image and a STEM image; thus, in the TEM image of the positive electrode active material particle 100, a difference between constituent elements of the first region 101 and those of the second region 102 can be observed. Furthermore, it can be observed that the first region 101 and the second region 102 contain different elements from an EDX element distribution image as well. However, a clear boundary between the first region 101 and the second region 102 is not necessarily observed by the analyses.

The concentrations of lithium, the element M, magnesium, and fluorine can be analyzed by ToF-SIMS, XPS, Auger electron spectroscopy, TDS, or the like.

Note that XPS allows quantitative analysis at a depth of approximately 5 nm from the surface of the positive electrode active material particle 100. Thus, when the thickness of the second region 102 is less than 5 nm, the element concentrations in a region composed of the second region 102 and part of the first region 101 can be quantitatively analyzed. When the thickness of the second region 102 is 5 nm or more from the surface, the element concentrations in the second region 102 can be quantitatively analyzed.

The Li/M in the positive electrode active material particle 100 measured by XPS is, for example, higher than or equal to 0.5 and lower than or equal to 0.85.

The atomic ratio of magnesium to the element M (hereinafter referred to as Mg/M) in the positive electrode active material particle 100 measured by XPS is preferably higher than 0.15, more preferably higher than or equal to 0.2 and lower than or equal to 0.5, still more preferably higher than or equal to 0.3 and lower than or equal to 0.4.

The atomic ratio of fluorine to the element M (hereinafter referred to as F/M) in the positive electrode active material particle 100 measured by XPS is preferably higher than or equal to 0.02 and lower than or equal to 0.15.

The crystal structures of the first region 101 and the second region 102 can be evaluated by analyzing an electron diffraction image or an inverse fast Fourier transform image of a TEM image, for example

### <Third Region 103>

Although the example in which the positive electrode active material particle 100 includes the first region 101 and the second region 102 is described above, one embodiment of the present invention is not limited thereto. For example, as illustrated in FIG. 1C, the positive electrode active material particle 100 may include a third region 103. The third region 103 can be provided in contact with at least a part of the second region 102, for example The third region 103 may be a coating film containing carbon, such as a graphene compound, or may be a coating film containing lithium or a decomposition product of an electrolytic solution. When the third region 103 is a coating film containing carbon, it is possible to increase the conductivity between the positive electrode active material particles 100 and between the positive electrode active material particle 100 and the current collector. In the case where the third region 103 is a coating film containing lithium or a decomposition product of an electrolytic solution, an excessive reaction with the electrolytic solution can be inhibited; thus, such a structure can improve the cycle performance of a secondary battery.

### [Manufacturing Method]

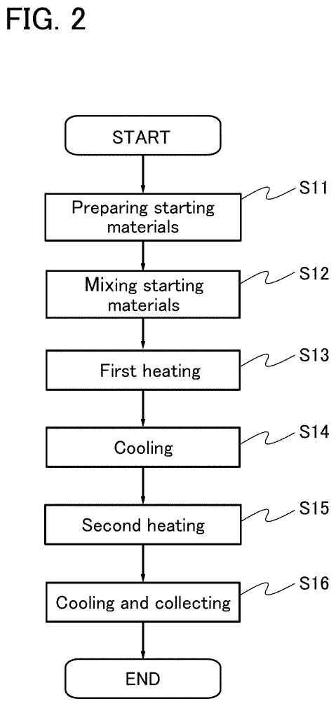

A manufacturing method of the positive electrode active material particle 100 including the first region 101 and the second region 102 formed by segregation will be described with reference to FIG. 2.

First, starting materials are prepared (S11). Specifically, a lithium source, an element M source, a magnesium source, and a fluorine source were individually weighed. As the lithium source, for example, lithium carbonate, lithium fluoride, or lithium hydroxide can be used. In the case where the element M is cobalt, cobalt oxide, cobalt hydroxide, cobalt oxyhydroxide, cobalt carbonate, cobalt oxalate, cobalt sulfate, or the like can be used as a cobalt source, for example. As the magnesium source, for example, magnesium oxide, magnesium fluoride, or the like can be used. As the fluorine source, for example, lithium fluoride, magnesium fluoride, or the like can be used. That is, lithium fluoride can be used as both a lithium source and a fluorine source. Magnesium fluoride can be used as both a magnesium source and a fluorine source.

In this embodiment, lithium carbonate (Li₂CO₃) is used as a lithium source, cobalt oxide (Co₃O₄) is used as a cobalt source, magnesium oxide (MgO) is used as a magnesium source, lithium fluoride (LiF) is used as a lithium source and a fluorine source.

In one embodiment of the present invention, a magnesium source and a fluorine source are mixed as starting materials at the same time, whereby the second region 102 containing magnesium and fluorine can be formed in the superficial portion of the positive electrode active material particle 100.

Here, the value obtained by dividing the sum of the number of lithium atoms in the starting materials by the sum of the element M atoms is (Li/M)_R.

Next, the weighed starting materials are mixed (S12). For example, a ball mill, a bead mill, and the like can be used for the mixing.

Next, the materials mixed in S12 are subjected to first heating (S13). The first heating is preferably performed at higher than or equal to 800° C. and lower than or equal to 1050° C., more preferably at higher than or equal to 900° C. and lower than or equal to 1000° C. The heating time is preferably longer than or equal to 2 hours and shorter than or equal to 20 hours. The heating is preferably performed in an atmosphere such as dry air. In this embodiment, the heating is performed at 1000° C. for 10 hours, the temperature rising rate is 200° C./h, and dry air flows at 10 L/min

By the first heating in S13, the first region 101 is formed. Here, (Li/M)_R is set low, whereby the amount of element M is excessive. Owing to the excessive amount of element M, a layer containing the excessive amount of element M as a main component is easily formed on the outside of the first region 101. For example, when the Li/M of the whole positive electrode active material particle 100 is set lower than the Li/M of a complex oxide in the first region 101, that is, when an excessive amount of element M is made to be generated, the second region 102 containing the element M and oxygen is formed on the outside of the first region 101.

Note that the first heating in S13 makes part of lithium to be released to the outside of the system, namely, to the outside of a particle to be manufactured, in some cases. That is, part of lithium is lost. Thus, the Li/M in the whole positive electrode active material particle after S16 is performed is lower than (Li/M)_R (the ratio of lithium to the element M in a material) in some cases.

Formation of the first region 101 and the second region 102 will be more specifically described below.

For example, the case where the element M is cobalt and the first region 101 contains lithium cobalt oxide will be described. The Li/M in the lithium cobalt oxide is in the neighborhood of 1. When the Li/M in the whole positive electrode active material particle is set lower than 1, the second region 102 containing the element M and oxygen is formed on the outside of the first region 101.

In view of loss of part of lithium, (Li/M)_R is set lower than 1.05, for example, whereby the second region 102 containing cobalt is formed on the outside of the first region 101.

When (Li/M)_R is set high, the specific surface area of the positive electrode active material particle decreases in some cases.

The second region 102 is preferably stable even in charging and discharging process of a secondary battery. There is almost no change in the valence of a metal other than a transition metal, such as magnesium; thus, a compound of the metal other than a transition metal is more stable than a transition metal compound in a secondary battery using a reduction-oxidation reaction, e.g., a lithium-ion battery. When the second region 102 contains magnesium, a side reaction at the surface of the positive electrode active material particle 100 is inhibited. Therefore, the second region 102 preferably contains magnesium.

However, according to the experimental results by the inventors, when (Li/M)_R (here, the element M was cobalt) was high, that is, the atomic ratio of cobalt to all the materials was low, the thickness of the second region 102 was small or the second region 102 was not easily formed in some cases.

In the case where the second region 102 is not easily formed, the concentration of magnesium in the first region 101 might increase. Magnesium in the first region 101 might inhibit charge and discharge. For example, discharge capacity or cycle performance might be decreased.

The inventors have found that the second region 102 containing magnesium and having a rock-salt crystal structure is formed by causing segregation of magnesium in the second region 102 after or at the same time as a condition where an excessive amount of cobalt exists is created to form a region containing lithium cobalt oxide as the first region 101 and form a region containing cobalt as its skeleton as the second region 102.

The first heating in S13 causes segregation of part of magnesium and part of fluorine in the second region 102. Part of magnesium may be substituted by cobalt contained in the second region 102, for example Part of fluorine may be substituted by oxygen contained in the second region 102, for example. Note that the rest of the magnesium and the rest of the fluorine at this stage form a solid solution in the complex oxide containing lithium and a transition metal.

Furthermore, adding fluorine to the positive electrode active material of one embodiment of the present invention may promote segregation of magnesium in the second region 102.

When fluorine is substituted for oxygen bonded to magnesium, magnesium easily moves around the substituted fluorine in some cases.

Adding magnesium fluoride to magnesium oxide may lower the melting point, in which case atoms easily move in heat treatment.

Fluorine has higher electronegativity than oxygen. Thus, even in a stable compound such as magnesium oxide, when fluorine is added, uneven charge distribution occurs and thus a bond between magnesium and oxygen is weakened in some cases.

For these reasons, in some cases, adding fluorine to the positive electrode active material of one embodiment of the present invention helps magnesium move easily, and segregation of magnesium in the second region occurs easily.

Next, the materials heated in S13 are cooled to room temperature (S14).

Next, the materials cooled in S14 are subjected to second heating (S15). It is preferred that the second heating be performed for a holding time at a specified temperature of 50 hours or shorter, more preferably 2 hours or longer and 10 hours or shorter. The specified temperature is preferably higher than or equal to 500° C. and lower than or equal to 1200° C., more preferably higher than or equal to 700° C. and lower than or equal to 1000° C., still more preferably about 800° C. The heating is preferably performed in an oxygen-containing atmosphere. In this embodiment, the heating is performed at 800° C. for 2 hours, the temperature rising rate is 200° C./h, and dry air flows at 10 L/min

The second heating in S15 facilitates segregation of the magnesium and fluorine contained in the starting materials, in the superficial portion of the complex oxide containing lithium and a transition metal, so that the concentrations of magnesium and fluorine in the second region 102 can be increased.

Finally, the materials heated in S15 are cooled to room temperature and the cooled materials are collected (S16), so that the positive electrode active material particle 100 can be obtained.

The use of the positive electrode active material particle described in this embodiment allows fabrication of a secondary battery with high capacity and excellent cycle performance. This embodiment can be implemented in appropriate combination with any of the other embodiments.

### Embodiment 2

In this embodiment, examples of materials that can be used for a secondary battery including the positive electrode active material particle 100 described in the above embodiment will be described. In this embodiment, a secondary battery in which a positive electrode, a negative electrode, and an electrolytic solution are wrapped in an exterior body will be described as an example

### [Positive Electrode]

The positive electrode includes a positive electrode active material layer and a positive electrode current collector.

### <Positive Electrode Active Material Layer>

The positive electrode active material layer includes positive electrode active material particles. The positive electrode active material layer may include a conductive additive and a binder.

As the positive electrode active material particles, the positive electrode active material particles 100 described in the above embodiment can be used. The use of the positive electrode active material particles 100 described in the above embodiment allows fabrication of a secondary battery with high capacity and excellent cycle performance.

Examples of the conductive additive include a carbon material, a metal material, and a conductive ceramic material. Alternatively, a fiber material may be used as the conductive additive. The content of the conductive additive in the active material layer is preferably greater than or equal to 1 wt % and less than or equal to 10 wt %, more preferably greater than or equal to 1 wt % and less than or equal to 5 wt %.

A network for electric conduction can be formed in the active material layer by the conductive additive. The conductive additive also allows maintaining of a path for electric conduction between the positive electrode active material particles. The addition of the conductive additive to the active material layer increases the electric conductivity of the active material layer.

Examples of the conductive additive include natural graphite, artificial graphite such as mesocarbon microbeads, and carbon fiber. Examples of carbon fiber include mesophase pitch-based carbon fiber, isotropic pitch-based carbon fiber, carbon nanofiber, and carbon nanotube. Carbon nanotube can be formed by, for example, a vapor deposition method. Other examples of the conductive additive include carbon materials such as carbon black (e.g., acetylene black (AB)), graphite (black lead) particles, graphene, and fullerene. Alternatively, metal powder or metal fibers of copper, nickel, aluminum, silver, gold, or the like, a conductive ceramic material, or the like can be used.

Alternatively, a graphene compound may be used as the conductive additive.

A graphene compound has excellent electrical characteristics of high conductivity and excellent physical properties of high flexibility and high mechanical strength in some cases. A graphene compound has a planar shape. A Graphene compound enables low-resistance surface contact. Furthermore, a graphene compound has extremely high conductivity even with a small thickness in some cases and thus allows a conductive path to be formed in an active material layer efficiently even with a small amount. For this reason, it is preferred to use a graphene compound as the conductive additive because the area where the active material and the conductive additive are in contact with each other can be increased. In addition, it is preferred to use a graphene compound as the conductive additive because the electrical resistance can be reduced in some cases. Here, it is particularly preferred that graphene, multilayer graphene, or reduced graphene oxide (hereinafter referred to as RGO) be used as a graphene compound. Note that RGO refers to a compound obtained by reducing graphene oxide (GO), for example.

In the case where active material particles with a small diameter (e.g., 1 μm or less) are used, the specific surface area of the active material particles is large and thus more conductive paths for the active material particles are needed. In such a case, it is particularly preferred that a graphene compound that can efficiently form a conductive path even with a small amount be used.

A cross-sectional structure example of an active material layer 200 containing a graphene compound as the conductive additive will be described below.

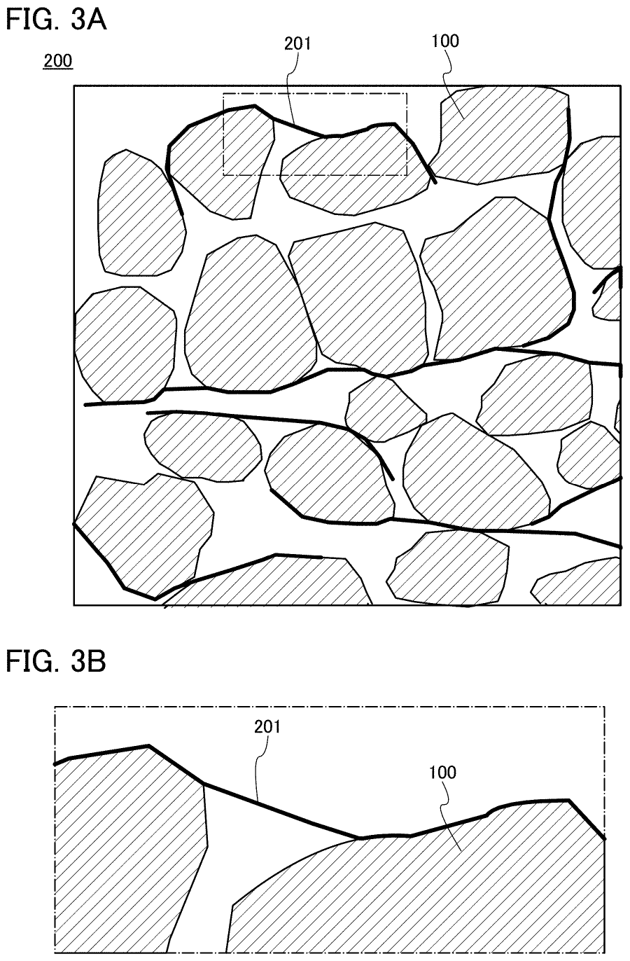

FIG. 3A shows a longitudinal cross-sectional view of the active material layer 200. The active material layer 200 includes the positive electrode active material particles 100, graphene compounds 201 serving as a conductive additive, and a binder (not illustrated). Here, graphene or multilayer graphene may be used as the graphene compound 201, for example The graphene compound 201 preferably has a sheet-like shape. The graphene compound 201 may have a sheet-like shape formed of a plurality of sheets of multilayer graphene and/or a plurality of sheets of graphene that partly overlap with each other.

The longitudinal cross section of the active material layer 200 in FIG. 3A shows substantially uniform dispersion of the sheet-like graphene compounds 201 in the active material layer 200. The graphene compounds 201 are schematically shown by thick lines in FIG. 3A but are actually thin films each having a thickness corresponding to the thickness of a single layer or a multi-layer of carbon molecules. The plurality of graphene compounds 201 are formed in such a way as to wrap, coat, or adhere to the surfaces of the plurality of positive electrode active material particles 100, so that the graphene compounds 201 make surface contact with the positive electrode active material particles 100.

Here, the plurality of graphene compounds are bonded to each other to form a net-like graphene compound sheet (hereinafter referred to as a graphene compound net or a graphene net). The graphene net covering the active material can function as a binder for bonding the active materials. The amount of the binder can thus be reduced, or the binder does not have to be used. This can increase the proportion of the active materials in the electrode volume or weight. That is to say, the capacity of the power storage device can be increased.

Here, it is preferred to perform reduction after a layer to be the active material layer 200 is formed in such a manner that graphene oxide is used as the graphene compound 201 and mixed with the active materials. In the case where graphene oxide with extremely high dispersibility in a polar solvent is used for the formation of the graphene compounds 201, the graphene compounds 201 can be substantially uniformly dispersed in the active material layer 200. The solvent is removed by volatilization from a dispersion medium in which graphene oxide is uniformly dispersed, and the graphene oxide is reduced; hence, the graphene compounds 201 remaining in the active material layer 200 partly overlap with each other and are dispersed such that surface contact is made, thereby forming a three-dimensional conduction path. Note that graphene oxide can be reduced either by heat treatment or with the use of a reducing agent, for example

Unlike a conductive additive in the form of particles, such as acetylene black, which makes point contact with an active material, the graphene compound 201 is capable of making low-resistance surface contact; accordingly, the electrical conduction between the active material particles 100 and the graphene compounds 201 can be improved with a small amount of the graphene compound 201 compared with a normal conductive additive. Thus, the proportion of the active material particles 100 in the active material layer 200 can be increased. Accordingly, the discharge capacity of a power storage device can be increased.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

For the binder, for example, water-soluble polymers are preferably used. As the water-soluble polymers, for example, a polysaccharide or the like can be used. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is more preferred that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, for example, a rubber material or the like is preferably mixed with a material having a significant viscosity modifying effect, for example As a material having a significant viscosity modifying effect, for example, a water-soluble polymer is preferably used. Examples of a water-soluble polymer having an especially significant viscosity modifying effect include the above-mentioned polysaccharides; for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and accordingly, easily exerts an effect as a viscosity modifier. The high solubility can also increase the dispersibility of an active material and other components in the formation of slurry for an electrode. In this specification, cellulose and a cellulose derivative used as a binder of an electrode include salts thereof.

A water-soluble polymer stabilizes viscosity by being dissolved in water and allows stable dispersion of the active material and another material combined as a binder, such as styrene-butadiene rubber, in an aqueous solution. Furthermore, a water-soluble polymer is expected to be easily and stably adsorbed to an active material surface because it has a functional group. Many cellulose derivatives such as carboxymethyl cellulose have functional groups such as a hydroxyl group and a carboxyl group. Because of functional groups, polymers are expected to interact with each other and cover an active material surface in a large area.

In the case where the binder covering or being in contact with the active material surface forms a film, the film is expected to serve as a passivation film to inhibit the decomposition of the electrolytic solution. Here, the passivation film refers to a film without electric conductivity or a film with extremely low electric conductivity, and can inhibit the decomposition of an electrolytic solution at a potential at which a battery reaction occurs in the case where the passivation film is formed on the active material surface, for example It is preferred that the passivation film can conduct lithium ions while inhibiting electric conduction.

### <Positive Electrode Current Collector>

The positive electrode current collector can be formed using a material that has high conductivity, such as a metal like stainless steel, gold, platinum, aluminum, or titanium, or an alloy thereof. It is preferred that a material used for the positive electrode current collector not dissolve at the potential of the positive electrode. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon are zirconium, titanium, hafnium, vanadium, niobium, tantalum, chromium, molybdenum, tungsten, cobalt, nickel, and the like. The current collector can have a foil-like shape, a plate-like shape (sheet-like shape), a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may include a conductive additive and a binder.

### <Negative Electrode Active Material>

As a negative electrode active material, for example, an alloy-based material or a carbon-based material can be used.

For the negative electrode active material, an element which enables charge-discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a significantly high theoretical capacity of 4200 mAh/g. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like. Here, an element that enables charge-discharge reactions by an alloying reaction and a dealloying reaction with lithium, a compound containing the element, and the like may be referred to as an alloy-based material.

In this specification and the like, SiO refers, for example, to silicon monoxide. SiO can alternatively be expressed as SiOₓ. Here, x preferably has an approximate value of 1. For example, x is preferably 0.2 or more and 1.5 or less, and more preferably 0.3 or more and 1.2 or less.

As the carbon-based material, graphite, graphitizing carbon (soft carbon), non-graphitizing carbon (hard carbon), a carbon nanotube, graphene, carbon black, or the like can be used.

Examples of graphite include artificial graphite and natural graphite. Examples of artificial graphite include meso-carbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and higher level of safety than that of a lithium metal.

Alternatively, for the negative electrode active materials, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active materials, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active materials and thus the negative electrode active materials can be used in combination with a material for a positive electrode active material which does not contain lithium ions, such as V₂O₅ or Cr₃O₈. In the case of using a material containing lithium ions as a positive electrode active material, the nitride containing lithium and a transition metal can be used for the negative electrode active material by extracting the lithium ions contained in the positive electrode active material in advance.

Alternatively, a material which causes a conversion reaction can be used for the negative electrode active materials; for example, a transition metal oxide which does not form an alloy with lithium, such as cobalt oxide (CoO), nickel oxide (NiO), and iron oxide (FeO), may be used. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as a positive electrode active material because of its high potential.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, a material similar to that for the positive electrode current collector can be used. Note that a material which is not alloyed with carrier ions such as lithium is preferably used for the negative electrode current collector.

[Electrolytic solution]

The electrolytic solution contains a solvent and an electrolyte. As the solvent of the electrolytic solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more kinds of ionic liquids (room temperature molten salts) which have features of non-flammability and non-volatility as a solvent of the electrolytic solution can prevent a power storage device from exploding or catching fire even when a power storage device internally shorts out or the internal temperature increases owing to overcharging or the like. An ionic liquid contains a cation and an anion. The ionic liquid of one embodiment of the present invention contains an organic cation and an anion. Examples of the organic cation used for the electrolytic solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolytic solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

The electrolytic solution used for a power storage device is preferably highly purified and contains a small amount of dust particles and elements other than the constituent elements of the electrolytic solution (hereinafter, also simply referred to as impurities). Specifically, the weight ratio of impurities to the electrolytic solution is less than or equal to 1%, preferably less than or equal to 0.1%, and more preferably less than or equal to 0.01%.

Furthermore, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolytic solution. The concentration of such an additive agent in the whole solvent is, for example, higher than or equal to 0.1 wt % and lower than or equal to 5 wt %.

Alternatively, a polymer gelled electrolyte obtained in such a manner that a polymer is swelled with an electrolytic solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP) can be used. The polymer may be porous.

Instead of the electrolytic solution, a solid electrolyte including an inorganic material such as a sulfide-based inorganic material or an oxide-based inorganic material, or a solid electrolyte including a macromolecular material such as a polyethylene oxide (PEO)-based macromolecular material may alternatively be used. When the solid electrolyte is used, a separator and a spacer are not necessary. Furthermore, the battery can be entirely solidified; therefore, there is no possibility of liquid leakage and thus the safety of the storage battery is dramatically increased.

### [Separator]

The secondary battery preferably includes a separator. As the separator, a fiber containing cellulose, such as paper; nonwoven fabric; a glass fiber; ceramics; a synthetic fiber containing nylon (polyamide), vinylon (polyvinyl alcohol based fiber), polyester, acrylic, polyolefin, or polyurethane; or the like can be used. The separator is preferably processed into a bag-like shape to enclose one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material are aluminum oxide particles and silicon oxide particles. Examples of the fluorine-based material are PVDF and a polytetrafluoroethylene. Examples of the polyamide-based material are nylon and aramid (meta-based aramid and para-based aramid).

Deterioration of the separator in charging and discharging at high voltage can be inhibited and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film in contact with the positive electrode may be coated with the mixed material of aluminum oxide and aramid and a surface of the polypropylene film in contact with the negative electrode may be coated with the fluorine-based material.

With the use of a separator having a multilayer structure, the capacity of the secondary battery per unit volume can be increased because the safety of the secondary battery can be maintained even when the total thickness of the separator is small.

### Embodiment 3

In this embodiment, examples of the shape of a secondary battery including the positive electrode active material particles 100 described in the above embodiment will be described. For materials used for the secondary battery described in this embodiment, the description of the above embodiment can be referred to.

### [Coin-Type Secondary Battery]

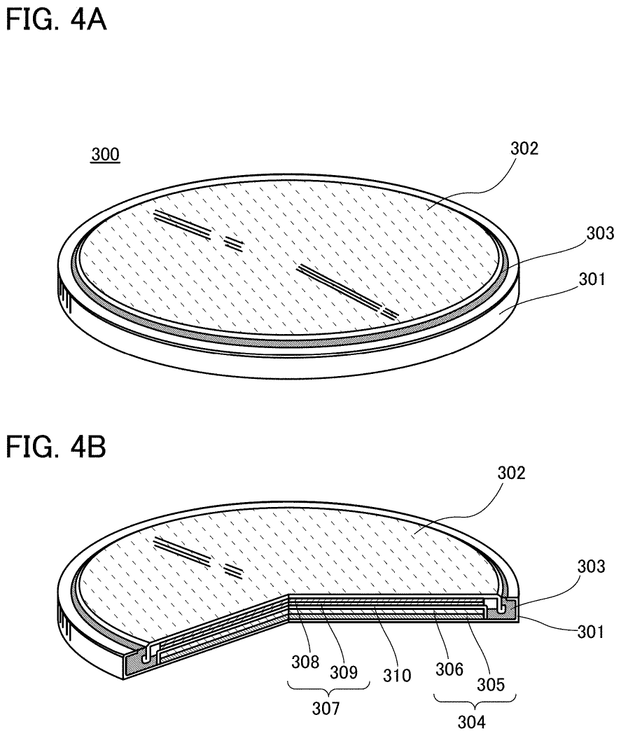

First, an example of a coin-type secondary battery will be described. FIG. 4A is an external view of a coin-type (single-layer flat type) secondary battery, and FIG. 4B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having a corrosion-resistant property to an electrolytic solution, such as nickel, aluminum, or titanium, an alloy of such a metal, or an alloy of such a metal and another metal (e.g., stainless steel or the like) can be used. Alternatively, the positive electrode can 301 and the negative electrode can 302 are preferably covered by nickel, aluminum, or the like in order to prevent corrosion due to the electrolytic solution. The positive electrode can 301 and the negative electrode can 302 are electrically connected to the positive electrode 304 and the negative electrode 307, respectively.

The negative electrode 307, the positive electrode 304, and the separator 310 are immersed in the electrolytic solution. Then, as illustrated in FIG. 4B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type secondary battery 300 can be manufactured.

When the positive electrode active material particles described in the above embodiment are used in the positive electrode 304, the coin-type secondary battery 300 with high capacity and excellent cycle performance can be obtained.

### [Cylindrical Secondary Battery]

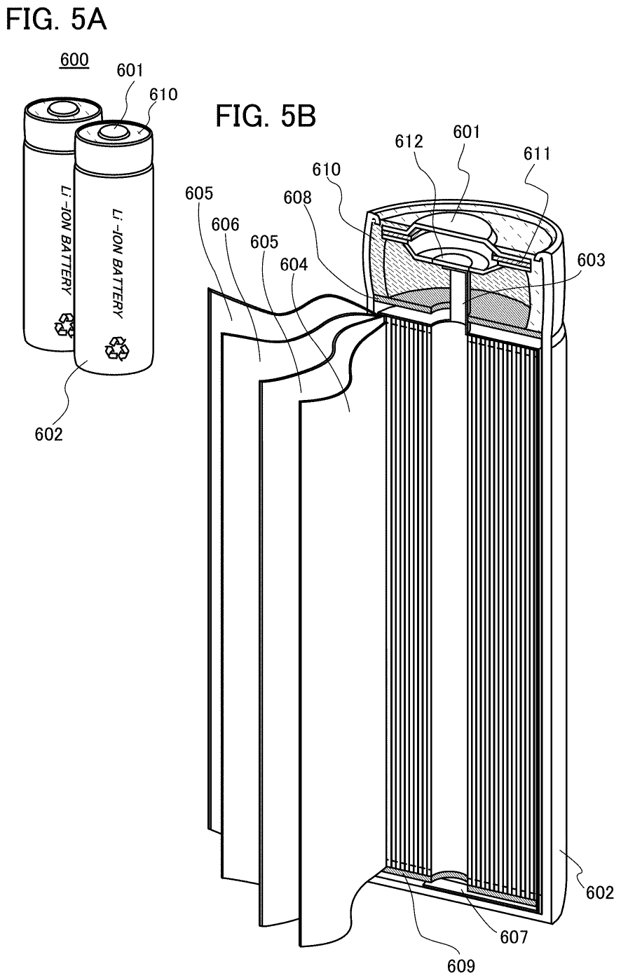

Next, an example of a cylindrical secondary battery will be described with reference to FIGS. 5A and 5B. As illustrated in FIG. 5A, a cylindrical secondary battery 600 includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 5B is a diagram schematically illustrating a cross section of the cylindrical secondary battery. Inside the battery can 602 having a hollow cylindrical shape, a battery element in which a strip-like positive electrode 604 and a strip-like negative electrode 606 are wound with a strip-like separator 605 interposed therebetween is provided. Although not illustrated, the battery element is wound around a center pin. One end of the battery can 602 is close and the other end thereof is open. For the battery can 602, a metal having a corrosion-resistant property to an electrolytic solution, such as nickel, aluminum, or titanium, an alloy of such a metal, or an alloy of such a metal and another metal (e.g., stainless steel or the like) can be used. Alternatively, the battery can 602 is preferably covered by nickel, aluminum, or the like in order to prevent corrosion due to the electrolytic solution. Inside the battery can 602, the battery element in which the positive electrode, the negative electrode, and the separator are wound is provided between a pair of insulating plates 608 and 609 which face each other. Furthermore, a nonaqueous electrolytic solution (not illustrated) is injected inside the battery can 602 provided with the battery element. As the nonaqueous electrolytic solution, a nonaqueous electrolytic solution that is similar to those of the coin-type secondary battery can be used.

Since the positive electrode and the negative electrode of the cylindrical secondary battery are wound, active materials are preferably formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the secondary battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

When the positive electrode active material particles described in the above embodiment are used in the positive electrode 604, the cylindrical secondary battery 600 with high capacity and excellent cycle performance can be obtained.

### [Structural Examples of Power Storage Devices]

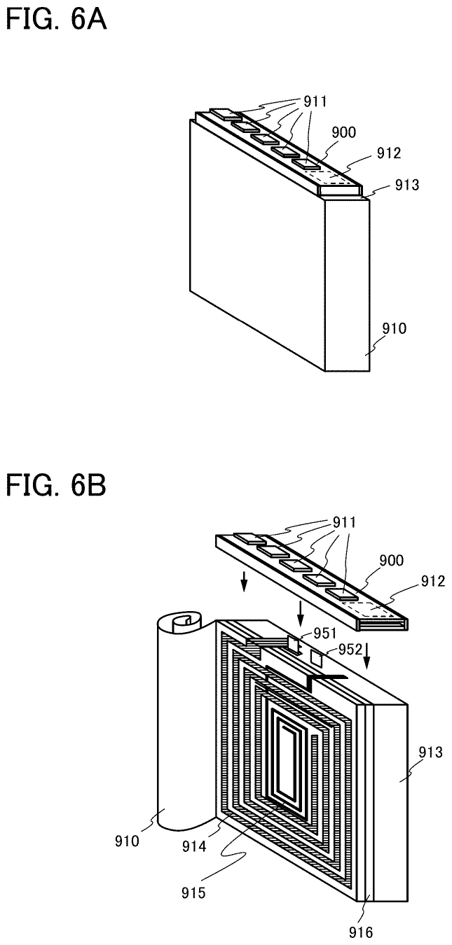

Other structural examples of power storage devices will be described with reference to FIGS. 6A and 6B to FIG. 10.

FIGS. 6A and 6B are external views of a power storage device. The power storage device includes a circuit board 900 and a secondary battery 913. A label 910 is attached to the secondary battery 913. As shown in FIG. 6B, the power storage device further includes a terminal 951, a terminal 952, an antenna 914, and an antenna 915.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may further be provided.

The circuit 912 may be provided on the rear surface of the circuit board 900. The shape of each of the antennas 914 and 915 is not limited to a coil shape and may be a linear shape or a plate shape. Further, a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage device includes a layer 916 between the secondary battery 913 and the antennas 914 and 915. The layer 916 may have a function of blocking an electromagnetic field by the secondary battery 913. As the layer 916, for example, a magnetic body can be used.

Note that the structure of the power storage device is not limited to that shown in FIGS. 6A and 6B.

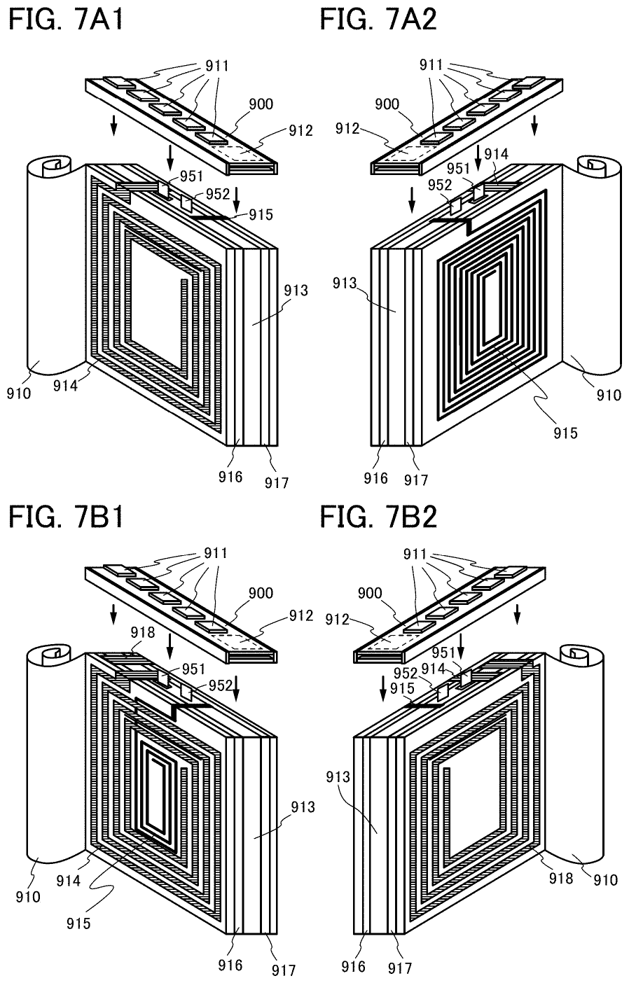

For example, as shown in FIGS. 7A1 and 7A2, two opposite surfaces of the secondary battery 913 in FIGS. 6A and 6B may be provided with respective antennas. FIG. 7A1 is an external view showing one side of the opposite surfaces, and FIG. 7A2 is an external view showing the other side of the opposite surfaces. For portions similar to those in FIGS. 6A and 6B, the description of the power storage device illustrated in FIGS. 6A and 6B can be referred to as appropriate.

As illustrated in FIG. 7A1, the antenna 914 is provided on one of the opposite surfaces of the secondary battery 913 with the layer 916 interposed therebetween, and as illustrated in FIG. 7A2, the antenna 915 is provided on the other of the opposite surfaces of the secondary battery 913 with a layer 917 interposed therebetween. The layer 917 may have a function of preventing an adverse effect on an electromagnetic field by the secondary battery 913. As the layer 917, for example, a magnetic body can be used.

With the above structure, both of the antennas 914 and 915 can be increased in size.

Alternatively, as illustrated in FIGS. 7B1 and 7B2, two opposite surfaces of the secondary battery 913 in FIGS. 6A and 6B may be provided with different types of antennas. FIG. 7B1 is an external view showing one side of the opposite surfaces, and FIG. 7B2 is an external view showing the other side of the opposite surfaces. For portions similar to those in FIGS. 6A and 6B, the description of the power storage device illustrated in FIGS. 6A and 6B can be referred to as appropriate.

As illustrated in FIG. 7B1, the antenna 914 is provided on one of the opposite surfaces of the secondary battery 913 with the layer 916 interposed therebetween, and as illustrated in FIG. 7B2, an antenna 918 is provided on the other of the opposite surfaces of the secondary battery 913 with the layer 917 interposed therebetween. The antenna 918 has a function of communicating data with an external device, for example An antenna with a shape that can be applied to the antennas 914 and 915, for example, can be used as the antenna 918. As a system for communication using the antenna 918 between the power storage device and another device, a response method that can be used between the power storage device and another device, such as NFC, can be employed.

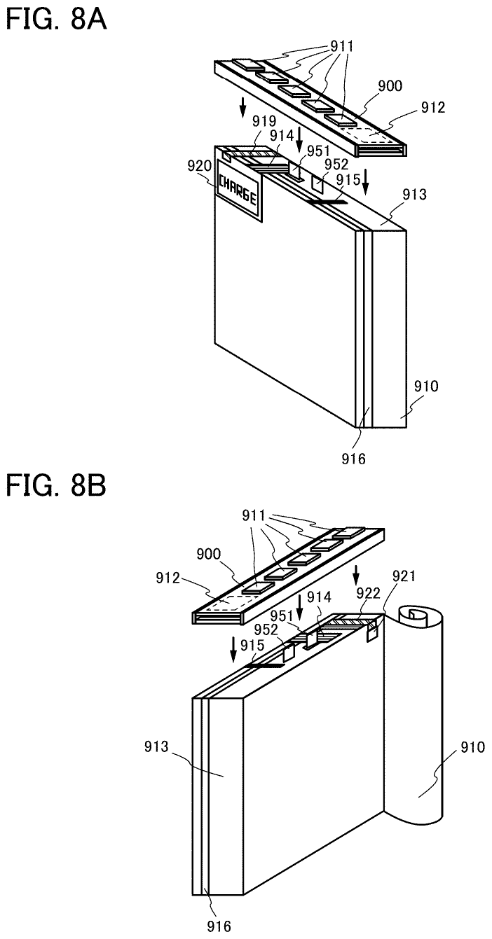

Alternatively, as illustrated in FIG. 8A, the secondary battery 913 in FIGS. 6A and 6B may be provided with a display device 920. The display device 920 is electrically connected to the terminal 911 via a terminal 919. It is possible that the label 910 is not provided in a portion where the display device 920 is provided. For portions similar to those in FIGS. 6A and 6B, the description of the power storage device illustrated in FIGS. 6A and 6B can be referred to as appropriate.

The display device 920 can display, for example, an image showing whether charge is being carried out, an image showing the amount of stored power, or the like. As the display device 920, electronic paper, a liquid crystal display device, an electroluminescent (EL) display device, or the like can be used. For example, the use of electronic paper can reduce power consumption of the display device 920.

Alternatively, as illustrated in FIG. 8B, the secondary battery 913 illustrated in FIGS. 6A and 6B may be provided with a sensor 921. The sensor 921 is electrically connected to the terminal 911 via a terminal 922. For portions similar to those in FIGS. 6A and 6B, the description of the power storage device illustrated in FIGS. 6A and 6B can be referred to as appropriate.

The sensor 921 has a function of measuring, for example, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays. With the sensor 921, for example, data on an environment (e.g., temperature) where the power storage device is placed can be determined and stored in a memory inside the circuit 912.

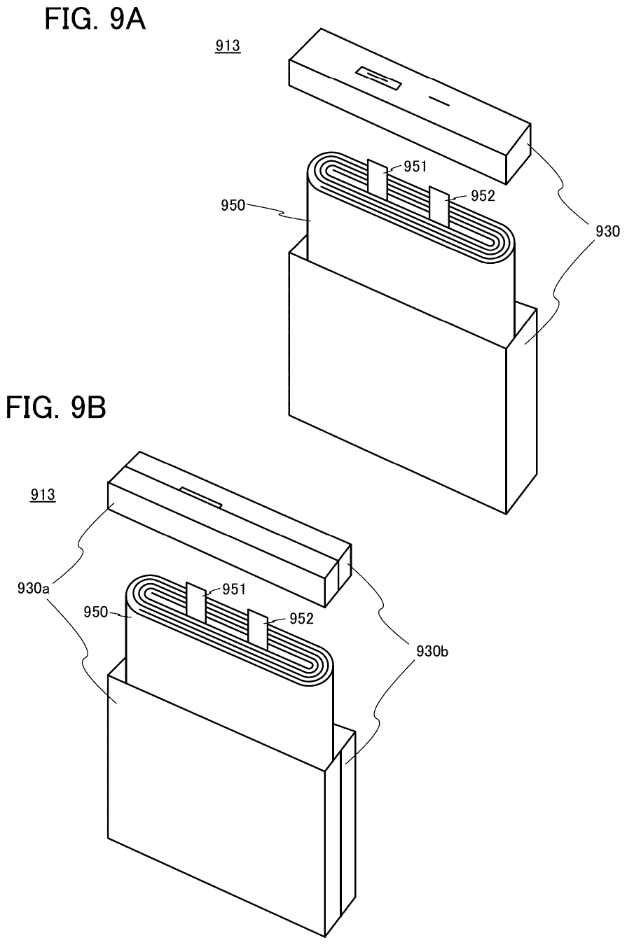

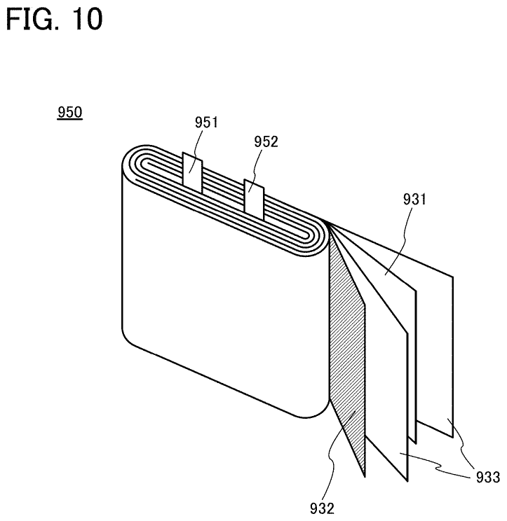

Furthermore, structural examples of the secondary battery 913 will be described with reference to FIGS. 9A and 9B and FIG. 10.

The secondary battery 913 illustrated in FIG. 9A includes a wound body 950 provided with the terminals 951 and 952 inside a housing 930. The wound body 950 is soaked in an electrolytic solution inside the housing 930. The terminal 952 is in contact with the housing 930. An insulator or the like inhibits contact between the terminal 951 and the housing 930. Note that in FIG. 9A, the housing 930 divided into two pieces is illustrated for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 9B, the housing 930 in FIG. 9A may be formed using a plurality of materials. For example, in the secondary battery 913 in FIG. 9B, a housing 930a and a housing 930b are bonded to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be prevented. When an electric field is not significantly blocked by the housing 930a, an antenna such as the antennas 914 and 915 may be provided inside the housing 930a. For the housing 930b, a metal material can be used, for example.

FIG. 10 illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other and are divided by the separator 933. Note that a plurality of stacks of the negative electrode 931, the positive electrode 932, and the separators 933 may be stacked.

The negative electrode 931 is connected to the terminal 911 in FIGS. 6A and 6B via one of the terminals 951 and 952. The positive electrode 932 is connected to the terminal 911 in FIGS. 6A and 6B via the other of the terminals 951 and 952.

When the positive electrode active material particles 100 described in the above embodiment are used in the positive electrode 932, the secondary battery 913 with high capacity and excellent cycle performance can be obtained.

### [Laminated Secondary Battery]

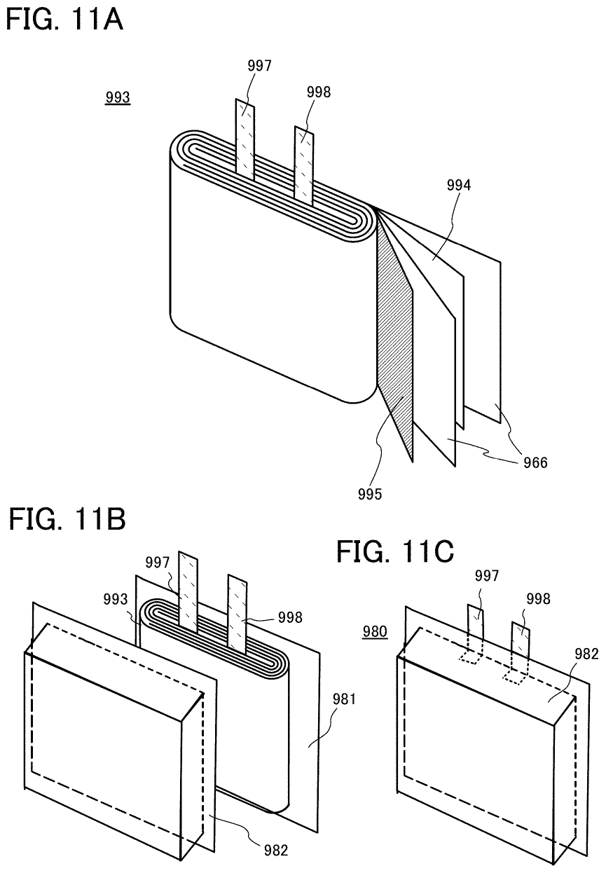

Next, an example of a laminated secondary battery will be described with reference to FIGS. 11A to 11C to FIGS. 17A and 17B. When a flexible laminated secondary battery is used in an electronic device at least part of which is flexible, the secondary battery can be bent as the electronic device is bent.

A laminated secondary battery 980 will be described with reference to FIGS. 11A to 11C. The laminated secondary battery 980 includes a wound body 993 illustrated in FIG. 11A. The wound body 993 includes a negative electrode 994, a positive electrode 995, and separators 966. The wound body 993 is, like the wound body 950 illustrated in FIG. 10, obtained by winding a sheet of a stack in which the negative electrode 994 and the positive electrode 995 overlap with each other and are divided by the separator 966.

Note that the number of stacks each including the negative electrode 994, the positive electrode 995, and the separator 966 is determined as appropriate depending on capacity and element volume which are required. The negative electrode 994 is connected to a negative electrode current collector (not illustrated) via one of a lead electrode 997 and a lead electrode 998. The positive electrode 995 is connected to a positive electrode current collector (not illustrated) via the other of the lead electrode 997 and the lead electrode 998.

As illustrated in FIG. 11B, the wound body 993 is packed in a space formed by bonding a film 981 and a film 982 having a depressed portion that serve as exterior bodies by thermocompression bonding or the like, whereby the secondary battery 980 can be formed as illustrated in FIG. 11C. The wound body 993 includes the lead electrode 997 and the lead electrode 998, and is soaked in an electrolytic solution inside a space surrounded by the film 981 and the film 982 having a depressed portion.

For the film 981 and the film 982 having a depressed portion, a metal material such as aluminum or a resin material can be used, for example With the use of a resin material for the film 981 and the film 982 having a depressed portion, the film 981 and the film 982 having a depressed portion can be changed in their forms when external force is applied; thus, a flexible secondary battery can be fabricated.

Although FIGS. 11B and 11C illustrate an example where a space is formed by two films, the wound body 993 may be placed in a space formed by bending one film

When the positive electrode active material particles 100 described in the above embodiment are used in the positive electrode 995, the secondary battery 980 with high capacity and excellent cycle performance can be obtained.

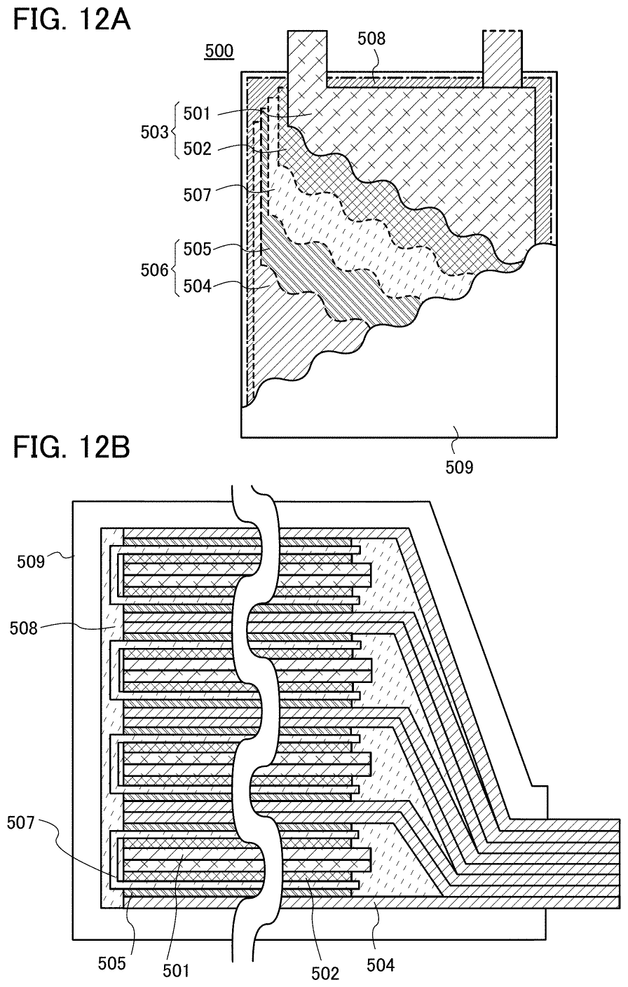

In FIGS. 11A to 11C, an example in which the secondary battery 980 includes a wound body in a space formed by films serving as an exterior body is described; however, as illustrated in FIGS. 12A and 12B, a secondary battery may include a plurality of strip-shaped positive electrodes, a plurality of strip-shaped separators, and a plurality of strip-shaped negative electrodes in a space formed by a film serving as an exterior body, for example

A laminated secondary battery 500 illustrated in FIG. 12A includes a positive electrode 503 including a positive electrode current collector 501 and a positive electrode active material layer 502, a negative electrode 506 including a negative electrode current collector 504 and a negative electrode active material layer 505, a separator 507, an electrolytic solution 508, and an exterior body 509. The separator 507 is provided between the positive electrode 503 and the negative electrode 506 in the exterior body 509. The electrolytic solution 508 is included in the exterior body 509. The electrolytic solution described in Embodiment 2 can be used for the electrolytic solution 508.

In the laminated secondary battery 500 illustrated in FIG. 12A, the positive electrode current collector 501 and the negative electrode current collector 504 also function as terminals for electrical contact with the outside. For this reason, each of the positive electrode current collector 501 and the negative electrode current collector 504 may be arranged so that part of the positive electrode current collector 501 and part of the negative electrode current collector 504 are exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

In the laminated secondary battery 500, as the exterior body 509, for example, a laminate film having a three-layer structure where a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide resin, a polyester resin, or the like is provided as the outer surface of the exterior body over the metal thin film can be used.

FIG. 12B illustrates an example of a cross-sectional structure of the laminated secondary battery 500. Although FIG. 12A illustrates an example of including only two current collectors for simplicity, the actual battery includes a plurality of electrode layers.

The example in FIG. 12B includes 16 electrode layers. The laminated secondary battery 500 has flexibility even though including 16 electrode layers. In FIG. 12B, eight negative electrode current collectors 504 and eight positive electrode current collectors 501 are included. Note that FIG. 12B illustrates a cross section of a lead portion of the negative electrode, and 8 negative electrode current collectors 504 are bonded to each other by ultrasonic welding. It is needless to say that the number of electrode layers is not limited to 16, and may be more than 16 or less than 16. With a larger number of electrode layers, a secondary battery can have higher capacity. In contrast, with a smaller number of electrode layers, a secondary battery can have a smaller thickness and higher flexibility.

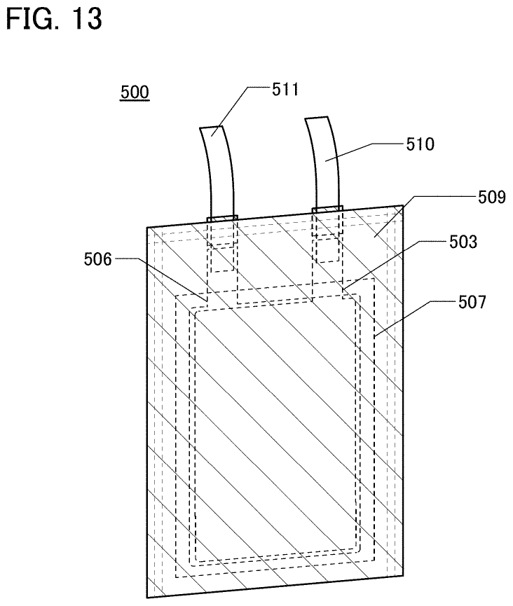

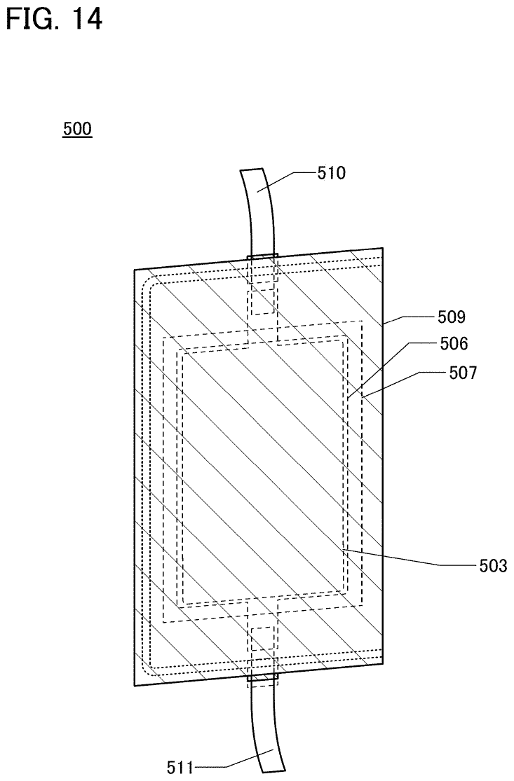

FIGS. 13 and 14 each illustrate an example of the external view of the laminated secondary battery 500. In FIGS. 13 and 14, the laminated secondary battery 500 includes the positive electrode 503, the negative electrode 506, the separator 507, the exterior body 509, a positive electrode lead electrode 510, and a negative electrode lead electrode 511.

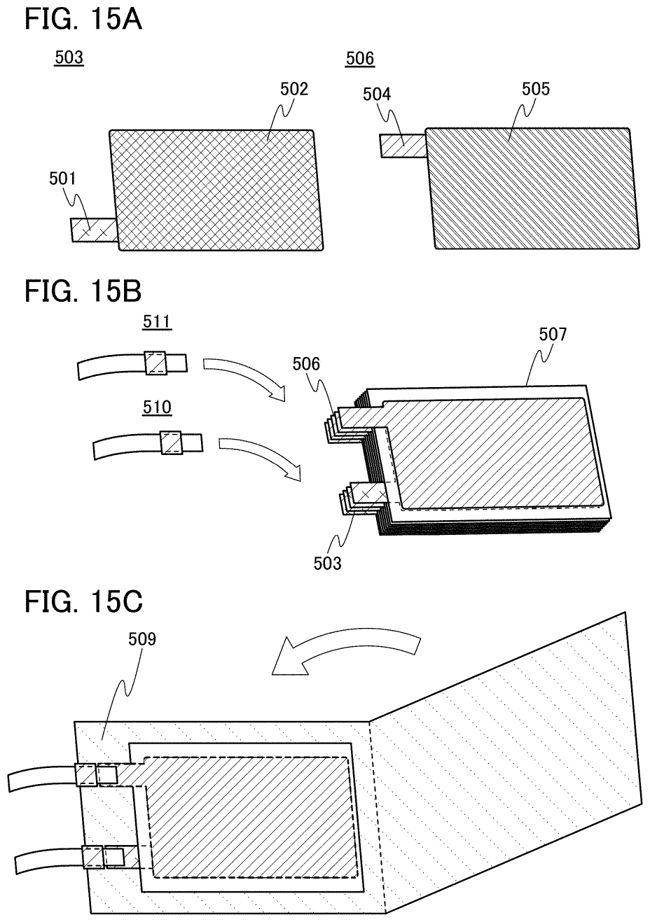

FIG. 15A illustrates the external views of the positive electrode 503 and the negative electrode 506. The positive electrode 503 includes the positive electrode current collector 501, and the positive electrode active material layer 502 is formed on a surface of the positive electrode current collector 501. The positive electrode 503 also includes a region where the positive electrode current collector 501 is partly exposed (hereinafter also referred to as a tab region). The negative electrode 506 includes the negative electrode current collector 504, and the negative electrode active material layer 505 is formed on a surface of the negative electrode current collector 504. The negative electrode 506 also includes a region where the negative electrode current collector 504 is partly exposed, that is, a tab region. The areas and shapes of the tab regions included in the positive electrode and negative electrode are not limited to those illustrated in FIG. 15A.

### [Fabricating Method of Laminated Secondary Battery]

Here, an example of a fabricating method of the laminated secondary battery whose external view is illustrated in FIG. 13 will be described with reference to FIGS. 15B and 15C.

First, the negative electrode 506, the separator 507, and the positive electrode 503 are stacked. FIG. 15B illustrates a stack of the negative electrode 506, the separator 507, and the positive electrode 503. The secondary battery described here as an example includes 5 negative electrodes and 4 positive electrodes. Next, the tab regions of the positive electrodes 503 are bonded to each other, and the tab region of the positive electrode of the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode of the outermost surface and the negative electrode lead electrode 511 are bonded to each other.

After that, the negative electrode 506, the separator 507, and the positive electrode 503 are placed over the exterior body 509.

Subsequently, the exterior body 509 is folded along a dashed line as illustrated in FIG. 15C. Then, the outer edges of the exterior body 509 are bonded. The bonding can be performed by thermocompression bonding, for example. At this time, a part (or one side) of the exterior body 509 is left unbonded (to provide an inlet) so that the electrolytic solution 508 can be introduced later.

Next, the electrolytic solution 508 is introduced into the exterior body 509 from the inlet of the exterior body 509. The electrolytic solution 508 is preferably introduced in a reduced pressure atmosphere or in an inert gas atmosphere. Lastly, the inlet is bonded. In the above manner, the laminated secondary battery 500 can be fabricated.

When the positive electrode active material particles 100 described in the above embodiment are used in the positive electrode 503, the secondary battery 500 with high capacity and excellent cycle performance can be obtained.

### [Bendable Secondary Battery]

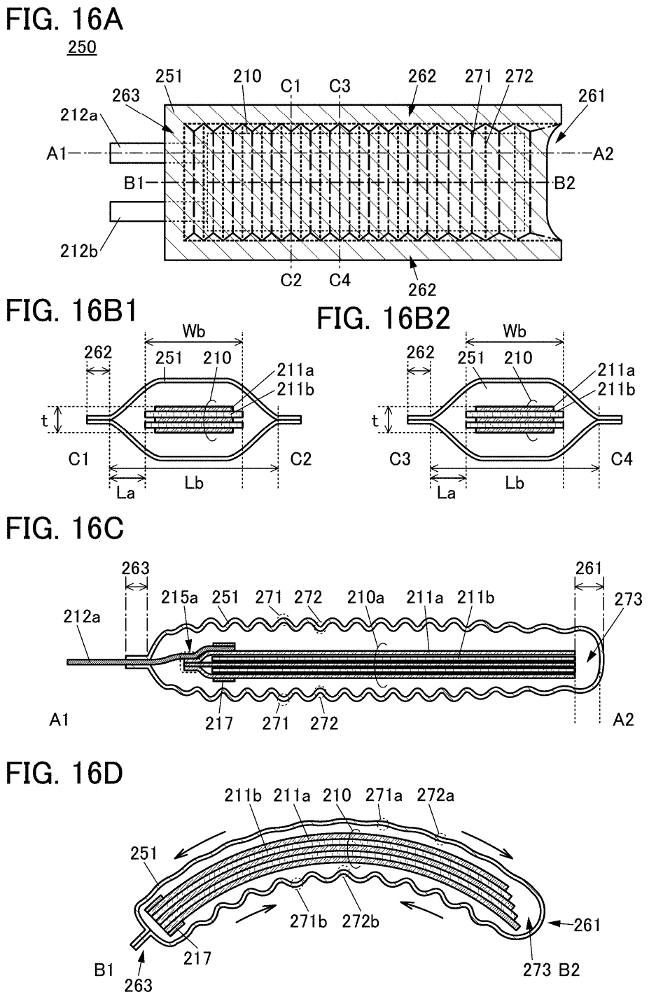

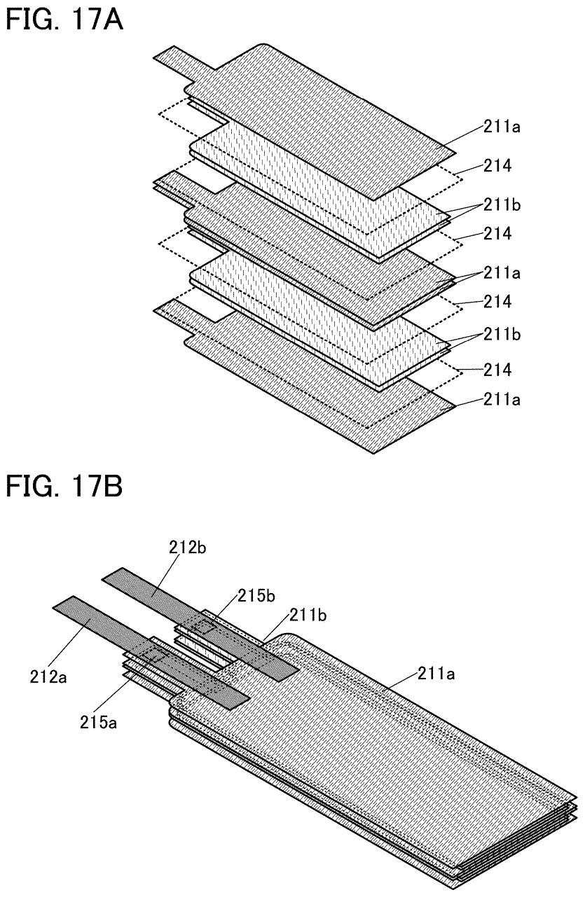

Next, an example of a bendable secondary battery will be described with reference to FIGS. 16A to 16D and FIGS. 17A and 17B.

FIG. 16A is a schematic top view of a bendable battery 250. FIGS. 16B1, 16B2, and 16C are schematic cross-sectional views taken along C1-C2, C3-C4, and A1-A2, respectively, in FIG. 16A. The battery 250 includes an exterior body 251 and a positive electrode 211a and a negative electrode 211b held in the exterior body 251. A lead 212a electrically connected to the positive electrode 211a and a lead 212b electrically connected to the negative electrode 211b are extended to the outside of the exterior body 251. In addition to the positive electrode 211a and the negative electrode 211b, an electrolytic solution (not illustrated) is enclosed in a region surrounded by the exterior body 251.

FIGS. 17A and 17B illustrate the positive electrode 211a and the negative electrode 211b included in the battery 250. FIG. 17A is a perspective view illustrating the stacking order of the positive electrode 211a, the negative electrode 211b, and the separator 214. FIG. 17B is a perspective view illustrating the lead 212a and the lead 212b in addition to the positive electrode 211a and the negative electrode 211b.

As illustrated in FIG. 17A, the battery 250 includes a plurality of strip-shaped positive electrodes 211a, a plurality of strip-shaped negative electrodes 211b, and a plurality of separators 214. The positive electrode 211a and the negative electrode 211b each include a projected tab portion and a portion other than the tab portion. A positive electrode active material layer is formed on one surface of the positive electrode 211a other than the tab portion, and a negative electrode active material layer is formed on one surface of the negative electrode 211b other than the tab portion.

The positive electrodes 211a and the negative electrodes 211b are stacked so that surfaces of the positive electrodes 211a on each of which the positive electrode active material layer is not formed are in contact with each other and that surfaces of the negative electrodes 211b on each of which the negative electrode active material layer is not formed are in contact with each other.

Furthermore, the separator 214 is provided between the surface of the positive electrode 211a on which the positive electrode active material layer is formed and the surface of the negative electrode 211b on which the negative electrode active material layer is formed. In FIG. 17A, the separator 214 is shown by a dotted line for easy viewing.

In addition, as illustrated in FIG. 17B, the plurality of positive electrodes 211a are electrically connected to the lead 212a in a bonding portion 215a. The plurality of negative electrodes 211b are electrically connected to the lead 212b in a bonding portion 215b.

Next, the exterior body 251 will be described with reference to FIGS. 16B1, 16B2, 16C, and 16D.

The exterior body 251 has a film-like shape and is folded in half with the positive electrodes 211a and the negative electrodes 211b between facing portions of the exterior body 251. The exterior body 251 includes a folded portion 261, a pair of seal portions 262, and a seal portion 263. The pair of seal portions 262 is provided with the positive electrodes 211a and the negative electrodes 211b positioned therebetween and thus can also be referred to as side seals. The seal portion 263 includes portions overlapping with the lead 212a and the lead 212b and can also be referred to as a top seal.

Part of the exterior body 251 that overlaps with the positive electrodes 211a and the negative electrodes 211b preferably has a wave shape in which crest lines 271 and trough lines 272 are alternately arranged. The seal portions 262 and the seal portion 263 of the exterior body 251 are preferably flat.

FIG. 16B1 shows a cross section along the part overlapping with the crest line 271. FIG. 16B2 shows a cross section along the part overlapping with the trough line 272. FIGS. 16B1 and 16B2 correspond to cross sections of the battery 250, the positive electrodes 211a, and the negative electrodes 211b in the width direction.

Here, the distance between an end portion of the negative electrode 211b in the width direction and the seal portion 262, that is, the distance between the end portion of the negative electrode 211b and the seal portion 262 is referred to as a distance La. When the battery 250 changes in shape, for example, is bent, the positive electrode 211a and the negative electrode 211b change in shape such that the positions thereof are shifted from each other in the length direction as described later. At the time, if the distance La is too short, the exterior body 251 and the positive electrode 211a and the negative electrode 211b are rubbed hard against each other, so that the exterior body 251 is damaged in some cases. In particular, when a metal film of the exterior body 251 is exposed, there is a concern that the metal film might be corroded by the electrolytic solution. Therefore, the distance La is preferably set as long as possible. However, if the distance La is too long, the volume of the battery 250 is increased.

The distance La between the end portion of the negative electrode 211b and the seal portion 262 is preferably increased as the total thickness of the stacked positive electrodes 211a and negative electrodes 211b is increased.

Specifically, when the total thickness of the stacked positive electrodes 211a and negative electrodes 211b is assumed to be as a thickness t, the distance La is preferably 0.8 times or more and 3.0 times or less, more preferably 0.9 times or more and 2.5 times or less, still more preferably 1.0 times or more and 2.0 times or less as large as the thickness t. When the distance La is in the above-described range, a compact battery highly reliable for bending can be obtained.

Furthermore, when a distance between the pair of seal portions 262 is assumed to be a distance Lb, it is preferred that the distance Lb be sufficiently longer than the widths of the positive electrode 211a and the negative electrode 211b (here, a width Wb of the negative electrode 211b ). In that case, even when the positive electrode 211a and the negative electrode 211b come into contact with the exterior body 251 by change in the shape of the battery 250, such as repeated bending, the position of part of the positive electrode 211a and the negative electrode 211b can be shifted in the width direction; thus, the positive and negative electrodes 211a and 211b and the exterior body 251 can be effectively prevented from being rubbed against each other.

For example, the difference between the distance La (i.e., the distance between the pair of seal portions 262) and the width Wb of the negative electrode 211b is preferably 1.6 times or more and 6.0 times or less, more preferably 1.8 times or more and 5.0 times or less, still more preferably 2.0 times or more and 4.0 times or less as large as the thickness t of the positive electrode 211a and the negative electrode 211b.

In other words, the distance Lb, the width Wb, and the thickness t preferably satisfy the relation of Formula 1 below.

Lb−Wb/2t≥α [Formula 1]

In the formula, α is 0.8 or more and 3.0 or less, preferably 0.9 or more and 2.5 or less, more preferably 1.0 or more and 2.0 or less.

FIG. 16C illustrates a cross section including the lead 212a and corresponds to a cross section of the battery 250, the positive electrode 211a, and the negative electrode 211b in the length direction. As illustrated in FIG. 16C, a space 273 is preferably provided between the end portions of the positive electrode 211a and the negative electrode 211b in the length direction and the exterior body 251 in the folded portion 261.

FIG. 16D is a schematic cross-sectional view of the battery 250 in a state of being bent. FIG. 16D corresponds to a cross section along B1-B2 in FIG. 16A.

When the battery 250 is bent, a part of the bent exterior body 251 positioned on the outer side is unbent and the other part positioned on the inner side changes its shape as it shrinks. More specifically, the part of the bent exterior body 251 positioned on the outer side changes its shape such that the wave amplitude becomes smaller and the length of the wave period becomes larger. In contrast, the part of the bent exterior body 251 positioned on the inner side changes its shape such that the wave amplitude becomes larger and the length of the wave period becomes smaller. When the exterior body 251 changes its shape in this manner, stress applied to the exterior body 251 due to bending is relieved, so that a material itself that forms the exterior body 251 does not need to expand and contract. Thus, the battery 250 can be bent with weak force without damage to the exterior body 251.

Furthermore, as illustrated in FIG. 16D, when the battery 250 is bent, the positions of the positive electrode 211a and the negative electrode 211b are shifted relatively. At this time, ends of the stacked positive electrodes 211a and negative electrodes 211b on the seal portion 263 side are fixed by the fixing member 217. Thus, the plurality of positive electrodes 211a and the plurality of negative electrodes 211b are more shifted at a position closer to the folded portion 261. Therefore, stress applied to the positive electrode 211a and the negative electrode 211b is relieved, and the positive electrode 211a and the negative electrode 211b themselves do not need to expand and contract. Consequently, the battery 250 can be bent without damage to the positive electrode 211a and the negative electrode 211b.

Furthermore, the space 273 is provided between the end portions of the positive and negative electrodes 211a and 211b and the exterior body 251, whereby the relative positions of the positive electrode 211a and the negative electrode 211b can be shifted while the end portions of the positive electrode 211a and the negative electrode 211b located on an inner side when the battery 250 is bent do not come in contact with the exterior body 251.

In the battery 250 illustrated in FIGS. 16A to 16D and FIGS. 17A and 17B, the exterior body, the positive electrode 211a, and the negative electrode 211b are less likely to be damaged and the battery characteristics are less likely to deteriorate even when the battery 250 is repeatedly bent and unbent. When the positive electrode active material particles 100 described in the above embodiment are used in the positive electrode 211a included in the battery 250, a battery with higher capacity and more excellent cycle performance can be obtained.

### Embodiment 4

In this embodiment, examples of electronic devices each including the secondary battery of one embodiment of the present invention will be described.

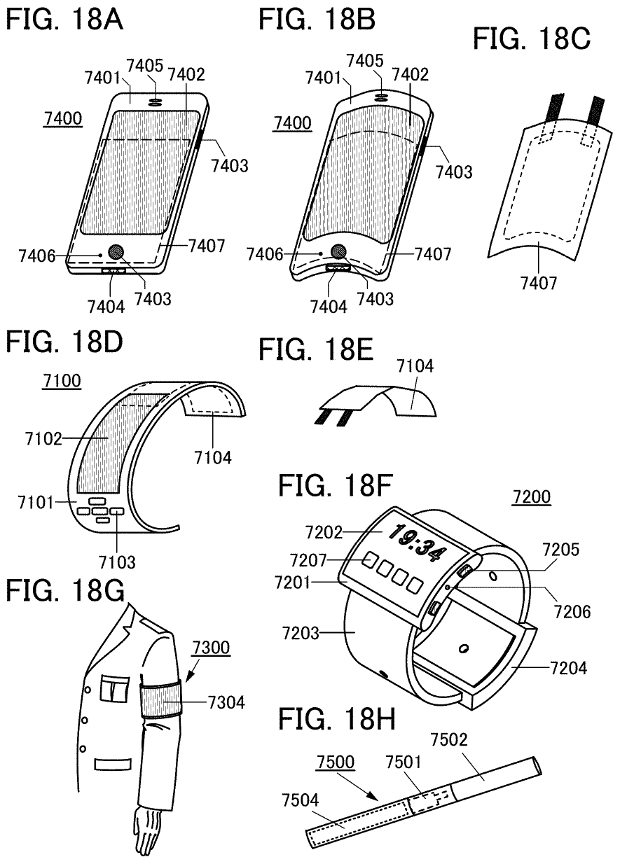

First, FIGS. 18A to 18G show examples of electronic devices including the bendable secondary battery described in Embodiment 3. Examples of electronic devices each including a bendable secondary battery include television sets (also referred to as televisions or television receivers), monitors of computers or the like, digital cameras and digital video cameras, digital photo frames, mobile phones (also referred to as cellular phones or mobile phone devices), portable game machines, portable information terminals, audio reproducing devices, and large game machines such as pachinko machines.

In addition, a flexible secondary battery can be incorporated along a curved inside/outside wall surface of a house or a building or a curved interior/exterior surface of a car.

FIG. 18A illustrates an example of a mobile phone. A mobile phone 7400 is provided with a display portion 7402 incorporated in a housing 7401, an operation button 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 18B illustrates the mobile phone 7400 that is bent. When the whole mobile phone 7400 is bent by the external force, the secondary battery 7407 included in the mobile phone 7400 is also bent. FIG. 18C illustrates the bent secondary battery 7407. The secondary battery 7407 is a thin secondary battery. The secondary battery 7407 is fixed in a state of being bent. Note that the secondary battery 7407 includes a lead electrode electrically connected to a current collector 7409.

FIG. 18D illustrates an example of a bangle display device. A portable display device 7100 includes a housing 7101, a display portion 7102, an operation button 7103, and a secondary battery 7104. FIG. 18E illustrates the bent secondary battery 7104. When the display device is worn on a user's arm while the secondary battery 7104 is bent, the housing changes its form and the curvature of a part or the whole of the secondary battery 7104 is changed. Note that the radius of curvature of a curve at a point refers to the radius of the circular arc that best approximates the curve at that point. The reciprocal of the radius of curvature is curvature. Specifically, a part or the whole of the housing or the main surface of the secondary battery 7104 is changed in the range of radius of curvature from 40 mm to 150 mm inclusive. When the radius of curvature at the main surface of the secondary battery 7104 is greater than or equal to 40 mm and less than or equal to 150 mm, the reliability can be kept high. When the secondary battery of one embodiment of the present invention is used as the secondary battery 7104, a lightweight portable display device with a long lifetime can be provided.

FIG. 18F illustrates an example of a watch-type portable information terminal. A portable information terminal 7200 includes a housing 7201, a display portion 7202, a band 7203, a buckle 7204, an operation button 7205, an input output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operation system incorporated in the portable information terminal 7200.

The portable information terminal 7200 can employ near field communication that is a communication method based on an existing communication standard. In that case, for example, mutual communication between the portable information terminal 7200 and a headset capable of wireless communication can be performed, and thus hands-free calling is possible.

Moreover, the portable information terminal 7200 includes the input output terminal 7206, and data can be directly transmitted to and received from another information terminal via a connector. In addition, charging via the input output terminal 7206 is possible. Note that the charging operation may be performed by wireless power feeding without using the input output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. For example, the secondary battery 7104 illustrated in FIG. 18E that is in the state of being curved can be provided in the housing 7201. Alternatively, the secondary battery 7104 illustrated in FIG. 18E can be provided in the band 7203 such that it can be curved.

A portable information terminal 7200 preferably includes a sensor. As the sensor, for example a human body sensor such as a fingerprint sensor, a pulse sensor, or a temperature sensor, a touch sensor, a pressure sensitive sensor, or an acceleration sensor is preferably mounted.

FIG. 18G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is bent, and images can be displayed on the bent display surface. A display state of the display device 7300 can be changed by, for example, near field communication, which is a communication method based on an existing communication standard.

The display device 7300 includes an input output terminal, and data can be directly transmitted to and received from another information terminal via a connector. In addition, charging via the input output terminal is possible. Note that the charging operation may be performed by wireless power feeding without using the input output terminal.

When the secondary battery of one embodiment of the present invention is used as the secondary battery included in the display device 7300, a lightweight display device with a long lifetime can be provided.

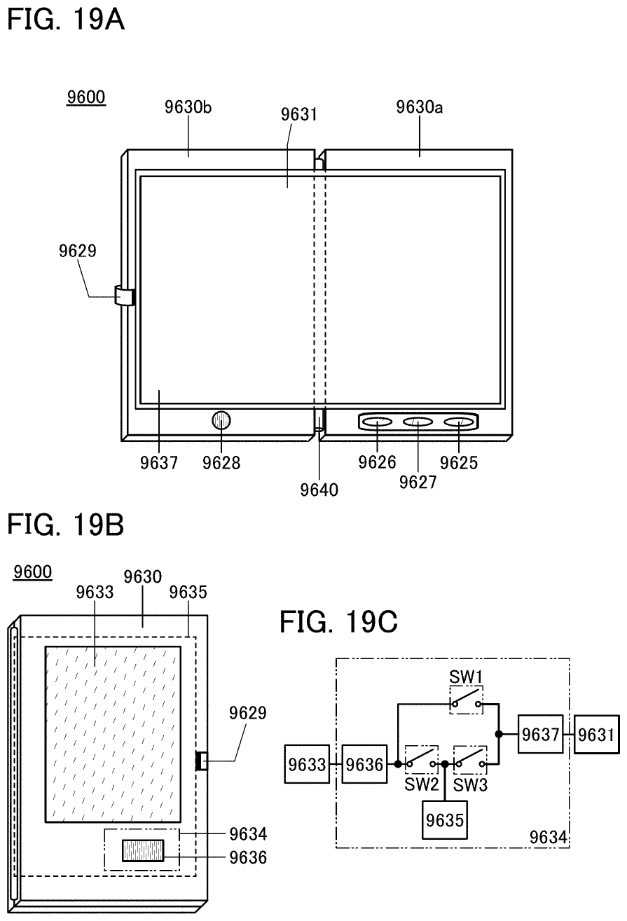

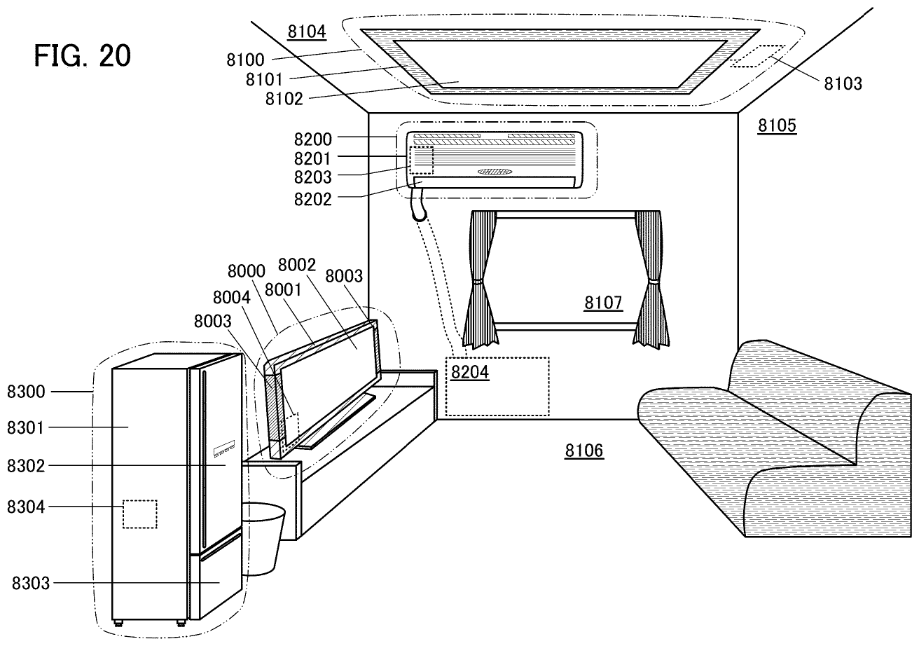

In addition, examples of electronic devices each including the secondary battery with excellent cycle performance described in the above embodiment will be described with reference to FIG. 18H, FIGS. 19A to 19C, and FIG. 20.

When the secondary battery of one embodiment of the present invention is used as a secondary battery of a daily electronic device, a lightweight product with a long lifetime can be provided. Examples of the daily electronic device include an electric toothbrush, an electric shaver, electric beauty equipment, and the like. As secondary batteries of these products, small and lightweight stick type secondary batteries with high capacity are desired in consideration ease in handling for users.

FIG. 18H is a perspective view of a device called a vaporizer (electronic cigarette). In FIG. 18H, a vaporizer 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and overdischarge of the secondary battery 7504 may be electrically connected to the secondary battery 7504. The secondary battery 7504 in FIG. 18H includes an output terminal for connection to a charger. When the vaporizer 7500 is held by a user, the secondary battery 7504 becomes a tip portion; thus, it is preferred that the secondary battery 7504 have a short total length and be lightweight. With the secondary battery of one embodiment of the present invention, which has high capacity and excellent cycle performance, the small and lightweight vaporizer 7500 that can be used for a long time over a long period can be provided.

Next, FIGS. 19A and 19B illustrate an example of a tablet terminal that can be folded in half. A tablet terminal 9600 illustrated in FIGS. 19A and 19B includes a housing 9630a, a housing 9630b, a movable portion 9640 connecting the housings 9630a and 9630b, a display portion 9631, a display mode changing switch 9626, a power switch 9627, a power saving mode changing switch 9625, a fastener 9629, and an operation switch 9628. A flexible panel is used for the display portion 9631, whereby a tablet terminal with a larger display portion can be provided. FIG. 19A illustrates the tablet terminal 9600 that is opened, and FIG. 19B illustrates the tablet terminal 9600 that is closed.

The tablet terminal 9600 includes a power storage unit 9635 inside the housings 9630a and 9630b. The power storage unit 9635 is provided across the housings 9630a and 9630b, passing through the movable portion 9640.

Part of the display portion 9631 can be a touch panel region, and data can be input by touching operation keys that are displayed. When a keyboard display switching button displayed on the touch panel is touched with a finger, a stylus, or the like, a keyboard can be displayed on the display portion 9631.

The display mode changing switch 9626 allows switching between a landscape mode and a portrait mode, color display and black-and-white display, and the like. The power saving mode changing switch 9625 can control display luminance in accordance with the amount of external light in use of the tablet terminal 9600, which is measured with an optical sensor incorporated in the tablet terminal 9600. In addition to the optical sensor, other detecting devices such as sensors for determining inclination, such as a gyroscope or an acceleration sensor, may be incorporated in the tablet terminal

The tablet terminal is closed in FIG. 19B. The tablet terminal includes the housing 9630, a solar cell 9633, and a charge and discharge control circuit 9634 including a DCDC converter 9636. The secondary battery of one embodiment of the present invention is used as the power storage unit 9635.

The tablet terminal 9600 can be folded such that the housings 9630a and 9630b overlap with each other when not in use. Thus, the display portion 9631 can be protected, which increases the durability of the tablet terminal 9600. With the power storage unit 9635 including the secondary battery of one embodiment of the present invention, which has high capacity and excellent cycle performance, the tablet terminal 9600 capable of being used for a long time over a long period can be provided.

The tablet terminal illustrated in FIGS. 19A and 19B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processing portion, and the like. Note that the solar cell 9633 can be provided on one or both surfaces of the housing 9630 and the power storage unit 9635 can be charged efficiently.

The structure and operation of the charge and discharge control circuit 9634 illustrated in FIG. 19B will be described with reference to a block diagram in FIG. 19C. The solar cell 9633, the power storage unit 9635, the DCDC converter 9636, a converter 9637, switches SW1 to SW3, and the display portion 9631 are illustrated in FIG. 19C, and the power storage unit 9635, the DCDC converter 9636, the converter 9637, and the switches SW1 to SW3 correspond to the charge and discharge control circuit 9634 in FIG. 19B.

First, an example of operation when electric power is generated by the solar cell 9633 using external light will be described. The voltage of electric power generated by the solar cell is raised or lowered by the DCDC converter 9636 to a voltage for charging the power storage unit 9635. When the display portion 9631 is operated with the electric power from the solar cell 9633, the switch SW1 is turned on and the voltage of the electric power is raised or lowered by the converter 9637 to a voltage needed for operating the display portion 9631. When display on the display portion 9631 is not performed, the switch SW1 is turned off and the switch SW2 is turned on, so that the power storage unit 9635 can be charged.

Note that the solar cell 9633 is described as an example of a power generation means; however, one embodiment of the present invention is not limited to this example The power storage unit 9635 may be charged using another power generation means such as a piezoelectric element or a thermoelectric conversion element (Peltier element). For example, the power storage unit 9635 may be charged with a non-contact power transmission module capable of performing charging by transmitting and receiving electric power wirelessly (without contact), or any of the other charge means used in combination.

FIG. 20 illustrates other examples of electronic devices. In FIG. 20, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, and the secondary battery 8004. The secondary battery 8004 of one embodiment of the present invention is provided in the housing 8001. The display device 8000 can receive electric power from a commercial power supply. Alternatively, the display device 8000 can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all of information display devices for personal computers, advertisement displays, and the like besides TV broadcast reception.

In FIG. 20, an installation lighting device 8100 is an example of an electronic device including a secondary battery 8103 of one embodiment of the present invention. Specifically, the lighting device 8100 includes a housing 8101, a light source 8102, and the secondary battery 8103. Although FIG. 20 illustrates the case where the secondary battery 8103 is provided in a ceiling 8104 on which the housing 8101 and the light source 8102 are installed, the secondary battery 8103 may be provided in the housing 8101. The lighting device 8100 can receive electric power from a commercial power supply. Alternatively, the lighting device 8100 can use electric power stored in the secondary battery 8103. Thus, the lighting device 8100 can be operated with the use of secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 20 as an example, the secondary battery of one embodiment of the present invention can be used in an installation lighting device provided in, for example, a wall 8105, a floor 8106, a window 8107, or the like other than the ceiling 8104. Alternatively, the secondary battery of one embodiment of the present invention can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 20, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, and the secondary battery 8203. Although FIG. 20 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can receive electric power from a commercial power supply. Alternatively, the air conditioner can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 20 as an example, the secondary battery of one embodiment of the present invention can be used in an air conditioner in which the functions of an indoor unit and an outdoor unit are integrated in one housing.

In FIG. 20, an electric refrigerator-freezer 8300 is an example of an electronic device including a secondary battery 8304 of one embodiment of the present invention. Specifically, the electric refrigerator-freezer 8300 includes a housing 8301, a door for a refrigerator 8302, a door for a freezer 8303, and the secondary battery 8304. The secondary battery 8304 is provided in the housing 8301 in FIG. 20. The electric refrigerator-freezer 8300 can receive electric power from a commercial power supply. Alternatively, the electric refrigerator-freezer 8300 can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

In addition, in a time period when electronic devices are not used, particularly when the proportion of the amount of electric power which is actually used to the total amount of electric power which can be supplied from a commercial power supply source (such a proportion referred to as a usage rate of electric power) is low, electric power can be stored in the secondary battery, whereby the usage rate of electric power can be reduced in a time period when the electronic devices are used. For example, in the case of the electric refrigerator-freezer 8300, electric power can be stored in the secondary battery 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the secondary battery 8304 is used as an auxiliary power supply; thus, the usage rate of electric power in daytime can be reduced.

The secondary battery of one embodiment of the present invention can be used in any of a variety of electronic devices as well as the above electronic devices. According to one embodiment of the present invention, the secondary battery can have excellent cycle characteristics. Furthermore, according to one embodiment of the present invention, a secondary battery with high capacity can be obtained, and the secondary battery itself can be made more compact and lightweight. Thus, the secondary battery of one embodiment of the present invention is used in the electronic device described in this embodiment, whereby the electronic device can be more lightweight and have a longer lifetime. This embodiment can be implemented in appropriate combination with any of the other embodiments.

### Embodiment 5

In this embodiment, examples of vehicles each including the secondary battery of one embodiment of the present invention will be described.

The use of secondary batteries in vehicles enables production of next-generation clean energy vehicles such as hybrid electric vehicles (HEVs), electric vehicles (EVs), and plug-in hybrid electric vehicles (PHEVs).

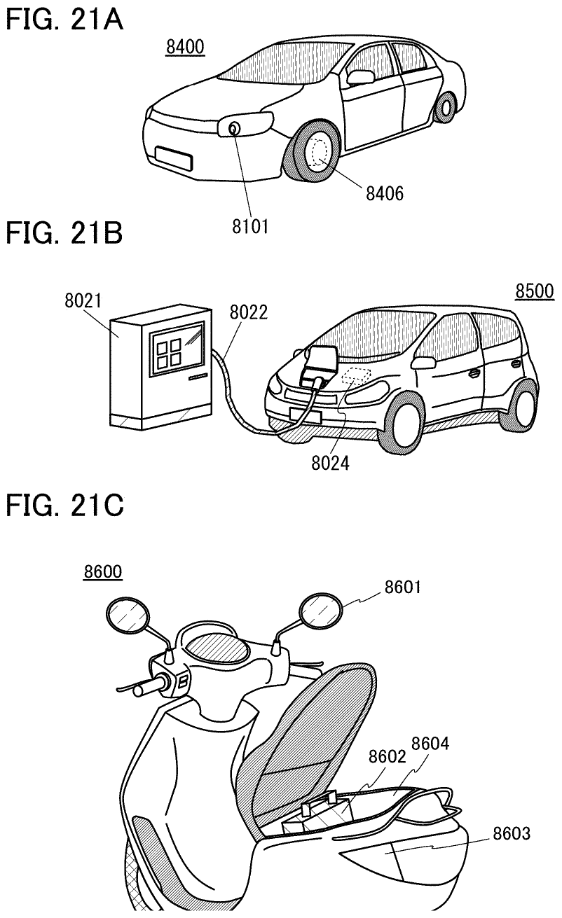

FIGS. 21A and 21B each illustrate an example of a vehicle using one embodiment of the present invention. An automobile 8400 illustrated in FIG. 21A is an electric vehicle that runs on the power of an electric motor. Alternatively, the automobile 8400 is a hybrid electric vehicle capable of driving appropriately using either an electric motor or an engine. The use of the secondary battery of one embodiment of the present invention allows fabrication of a high-mileage vehicle. The automobile 8400 includes the secondary battery. The secondary battery is used not only for driving an electric motor 8406, but also for supplying electric power to a light-emitting device such as a headlight 8401 or a room light (not illustrated).

The secondary battery can also supply electric power to a display device of a speedometer, a tachometer, or the like included in the automobile 8400. Furthermore, the secondary battery can supply electric power to a semiconductor device included in the automobile 8400, such as a navigation system.

FIG. 21B illustrates an automobile 8500 including the secondary battery. The automobile 8500 can be charged when a secondary battery 8024 is supplied with electric power through external charging equipment by a plug-in system, a contactless power feeding system, or the like. In FIG. 21B, the secondary battery 8024 included in the automobile 8500 is charged with the use of a ground-based charging apparatus 8021 through a cable 8022. In charging, a given method such as CHAdeMO (registered trademark) or Combined Charging System may be employed as a charging method, the standard of a connector, or the like as appropriate. The ground-based charging apparatus 8021 may be a charging station provided in a commerce facility or a power source in a house. For example, with the use of a plug-in technique, the secondary battery 8024 included in the automobile 8500 can be charged by being supplied with electric power from outside. The charging can be performed by converting AC electric power into DC electric power through a converter such as an AC-DC converter.

Furthermore, although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between vehicles. Furthermore, a solar cell may be provided in the exterior of the automobile to charge the secondary battery when the automobile stops or moves. To supply electric power in such a contactless manner, an electromagnetic induction method or a magnetic resonance method can be used.

FIG. 21C shows an example of a motorcycle using the secondary battery of one embodiment of the present invention. A motor scooter 8600 illustrated in FIG. 21C includes a secondary battery 8602, side mirrors 8601, and indicators 8603. The secondary battery 8602 can supply electric power to the indicators 8603.

Furthermore, in the motor scooter 8600 illustrated in FIG. 21C, the secondary battery 8602 can be held in a storage unit under seat 8604. The secondary battery 8602 can be held in the storage unit under seat 8604 even with a small size.

According to one embodiment of the present invention, the secondary battery can have improved cycle performance and the capacity of the secondary battery can be increased. Thus, the secondary battery itself can be made more compact and lightweight. The compact and lightweight secondary battery contributes to a reduction in the weight of a vehicle, and thus increases the driving radius. Furthermore, the secondary battery included in the vehicle can be used as a power source for supplying electric power to products other than the vehicle. In such a case, the use of a commercial power source can be avoided at peak time of electric power demand, for example Avoiding the use of a commercial power source at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example 1

In this example, positive electrode active material particles using cobalt as the element M were fabricated and evaluated.

### <Fabrication of Positive Electrode Active Material Particles>

Positive electrode active material particles with different concentrations of lithium sources and different concentrations of cobalt sources were fabricated as Samples 1 to 10. As starting materials, lithium carbonate (Li₂CO₃), tricobalt tetroxide (Co₃O₄), magnesium oxide (MgO), and lithium fluoride (LiF) were used.

The starting materials of each sample were weighed such that the molar ratio of lithium carbonate, tricobalt tetroxide, magnesium oxide, and lithium fluoride is as shown in Table 1.

TABLE 1

| | Li₂CO₃:Co₃O₄:MgO:LiF | Li/Co_R |
|---|---|---|
| Sample 1 | 0.485:0.33:0.01:0.02 | 1.000 |
| Sample 2 | 0.49:0.33:0.01:0.02 | 1.010 |
| Sample 3 | 0.495:0.33:0.01:0.02 | 1.020 |
| Sample 4 | 0.5:0.33:0.01:0.02 | 1.030 |
| Sample 5 | 0.5025:0.33:0.01:0.02 | 1.035 |
| Sample 6 | 0.505:0.33:0.01:0.02 | 1.040 |
| Sample 7 | 0.51:0.33:0.01:0.02 | 1.051 |
| Sample 8 | 0.515:0.33:0.01:0.02 | 1.061 |
| Sample 9 | 0.525:0.33:0.01:0.02 | 1.081 |
| Sample 10 | 0.55:0.33:0.01:0.02 | 1.131 |

As shown in Table 1, the sum of the number of lithium atoms in lithium carbonate and the number of lithium atoms in lithium fluoride is 1.000 time the number of cobalt atoms in tricobalt tetroxide for Sample 1, 1.010 times that for Sample 2, 1.020 times that for Sample 3, 1.030 times that for Sample 4, 1.035 times that for Sample 5, 1.040 times that for Sample 6, 1.051 times that for Sample 7, 1.061 times that for Sample 8, 1.081 times that for Sample 9, and 1.131 times that for Sample 10. In addition, the number of magnesium atoms in magnesium oxide is 0.010 times the number of cobalt atoms in tricobalt tetroxide. The number of fluorine atoms in lithium fluoride is 0.020 times the number of cobalt atoms in tricobalt tetroxide.

The positive electrode active material particles as the above 10 samples, Samples 1 to 10, were obtained in such a manner that starting materials were mixed, subjected to first heating, cooling, crushing, second heating, and cooling, and then collected as in the manufacturing method described in Embodiment 1. The first heating was performed at 1000° C. in a dry air atmosphere for 10 hours. The second heating was performed at 800° C. in a dry air atmosphere for 2 hours.

<Observation with SEM>

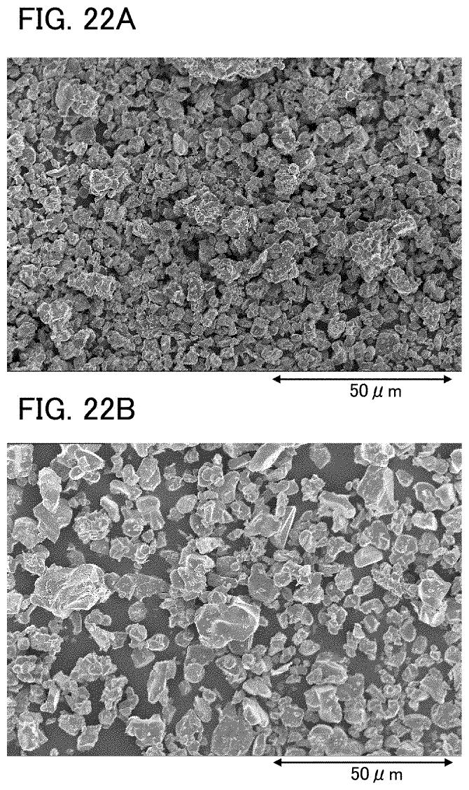

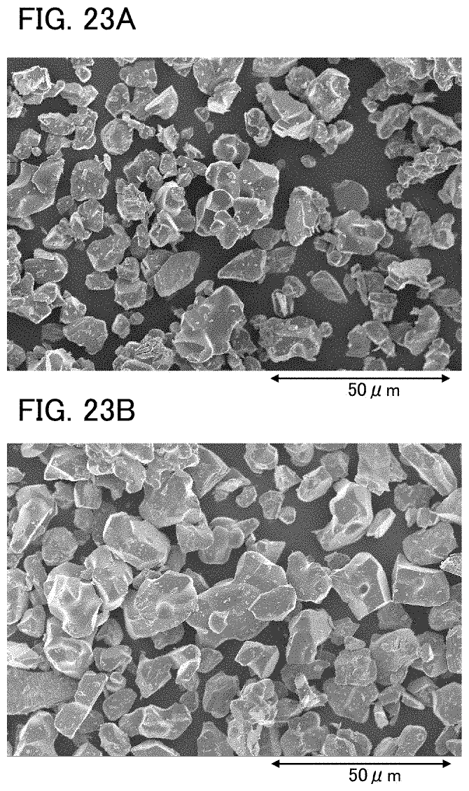

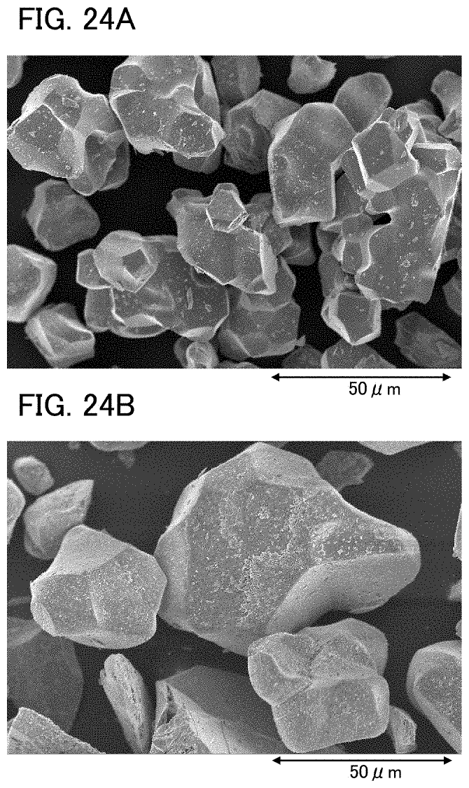

The obtained samples were observed with a scanning electron microscope (SEM). FIGS. 22A and 22B show observed Samples 1 and 4, FIGS. 23A and 23B show observed Samples 7 and 8, and FIGS. 24A and 24B show observed Samples 9 and 10. The observation results show that as Li/Co increases, the particle size increases. For Sample 4, many particles with a diameter of approximately 5 μm are observed. For Sample 8, many particles with a diameter of approximately 20 μm are observed. For Sample 10, particles with a diameter of larger than 50μm are observed.

### <Particle Size Distribution>

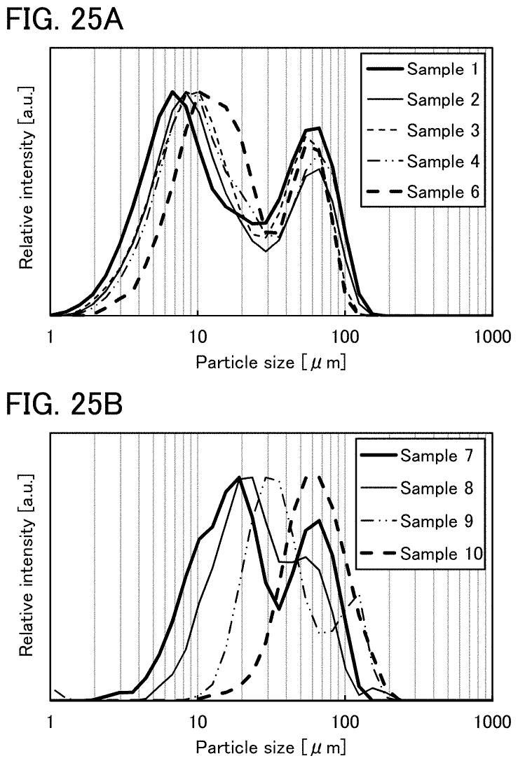

Next, the particle size distributions of Samples 1 to 4 and 6 to 10 among the obtained samples were measured. For the measurement, a laser diffraction particle size analyzer (SALD-2200 manufactured by Shimadzu Corporation) was used. FIGS. 25A and 25B show measurement results of Samples 1 to 4 and 6 to 10. FIG. 25A shows the results of Samples 1 to 4 and 6, and FIG. 25B shows the results of Samples 7 to 10. In FIGS. 25A and 25B, the vertical axis represents relative strength, and the horizontal axis represents particle size.

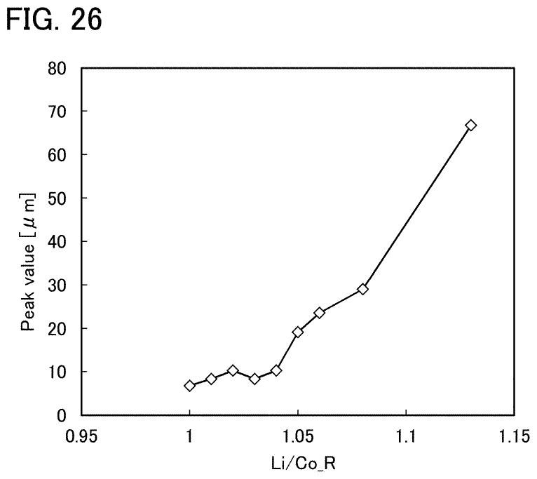

In FIG. 26, the horizontal axis represents the value ((Li/Co)_R) obtained by dividing the sum of the number of lithium atoms in lithium carbonate and the number of lithium atoms in lithium fluoride by the number of cobalt atoms in tricobalt tetroxide, and the vertical axis represents the peak value of relative strength, here, the particle size at the maximal relative strength.

The results show that as (Li/Co)_R increases, the peak value of particle size increases. A sharp increase in the peak value is observed at a (Li/Co)_R of around 1.05.

### Example 2

In this example, Samples 1 to 10 obtained in Example 1 were subjected to XPS analysis.

### <XPS Analysis>

Table 2 lists the compositions obtained by XPS analysis.

TABLE 2
[atomic %]

| | Li | Co | O | Mg | F | C | Ca | Na | Zr |
|---|---|---|---|---|---|---|---|---|---|
| Sample 1 | 10.0 | 19.5 | 47.8 | 5.3 | 1.6 | 13.4 | 0.5 | 1.5 | 0.5 |
| Sample 2 | 12.0 | 17.9 | 47.5 | 5.1 | 1.4 | 13.7 | 0.6 | 1.4 | 0.4 |
| Sample 3 | 10.3 | 19.3 | 48.4 | 5.3 | 1.7 | 12.7 | 0.4 | 1.2 | 0.7 |
| Sample 4 | 12.5 | 15.9 | 46.6 | 5.5 | 1.4 | 14.7 | 0.7 | 2.2 | 0.3 |
| Sample 5 | 12.8 | 19.8 | 46.2 | 6.4 | 2.1 | 9.5 | 0.5 | 2.2 | 0.4 |
| Sample 6 | 12.1 | 17.6 | 48.0 | 6.6 | 1.9 | 9.8 | 0.9 | 2.8 | 0.3 |
| Sample 7 | 11.1 | 16.5 | 50.1 | 5.7 | 1.5 | 10.6 | 0.6 | 3.5 | 0.4 |
| Sample 8 | 13.6 | 16.4 | 43.5 | 1.6 | 4.8 | 16.9 | 0.8 | 1.8 | 0.6 |
| Sample 9 | 13.1 | 16.3 | 45.4 | 0.5 | 4.2 | 16.9 | 1.3 | 1.6 | 0.6 |
| Sample 10 | 12.9 | 16.7 | 45.4 | 0.0 | 3.7 | 16.6 | 0.2 | 4.3 | 0.1 |

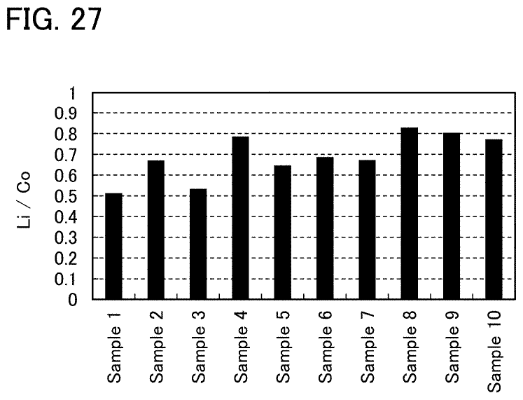

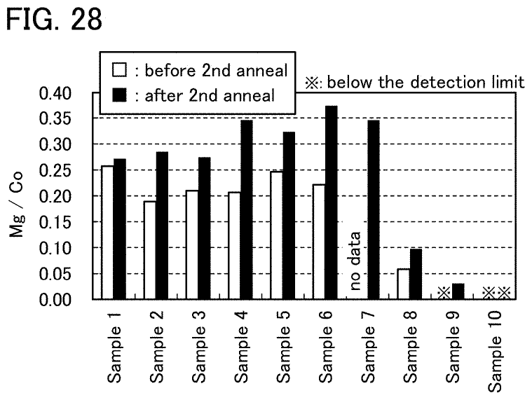

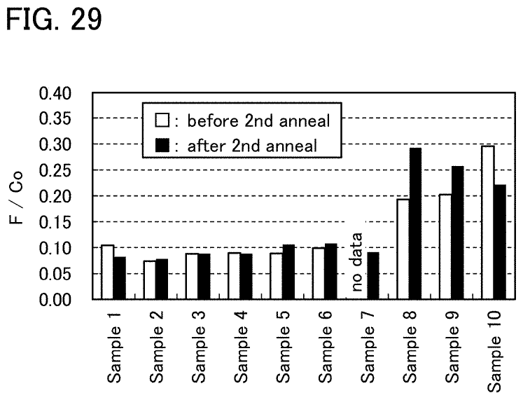

FIGS. 27 to 29 each show the atomic ratios in the samples obtained by XPS. FIG. 27 shows the ratios of lithium to cobalt (Li/Co). FIG. 28 shows the ratios of magnesium to cobalt (Mg/Co). FIG. 29 shows the ratios of fluorine to cobalt (F/Co). FIGS. 28 and 29 each show analysis results before the second heating (white bars in the graphs) and after completion of fabrication, that is, after the second heating (black bars in the graphs), in the fabrication process of the positive electrode active material particles.

As shown in FIG. 27, the Li/Co of each of the samples obtained by XPS was higher than 0.5 and lower than 0.85. The Li/Co of each of Samples 8 to 10 tended to be high. The results shown in FIG. 28 to be described later imply the possibility that the second region 102 might be thin or almost no second region 102 might be formed in each of Samples 8 to 10. Presumably, the proportion of the first region 101 in a region subjected to the XPS measurement is high and thus the Li/Co is close to 1, which is the ratio of lithium to cobalt in lithium cobalt oxide.

In addition, as shown in FIG. 28, Mg/Co tended to increase after the second heating. This suggests that the second heating further promotes segregation of magnesium.

As shown in FIG. 28, the Mg/Co of each of Samples 1 to 3 obtained by XPS was higher than 0.25 and lower than 0.3. The Mg/Co of each of Samples 4 to 6 obtained by XPS was higher than 0.3 and lower than 0.4. The Mg/Co of each of Samples 8 and 9 obtained by XPS was lower than or equal to 0.1. The amount of Mg in Sample 10 was below the lower limit of detection in XPS, that is, Mg was not detected. In each of Samples 8 to 10 where the (Li/Co)_R, which is the ratio of starting materials, was 1.061, a thin second region 102 or almost no second region 102 might be formed on the surface of the positive electrode active material particle because of a low concentration of magnesium.

As shown in FIG. 29, the F/Co of each of Samples 1 to 6 obtained by XPS was higher than 0.05 and lower than 0.15. The F/Co of each of Samples 8 to 10 obtained by XPS was higher than 0.2 and lower than 0.3. The concentrations of fluorine in Samples 8 to 10 where the (Li/Co)_R, which is the ratio of starting materials, was 1.061 tended to notably high. The increases in the concentrations of fluorine might be relative to the decreases in the concentrations of magnesium.

### Example 3

In this example, Samples 4 and 9 fabricated in Example 1 were subjected to cross-sectional TEM observation.

### <TEM Observation>

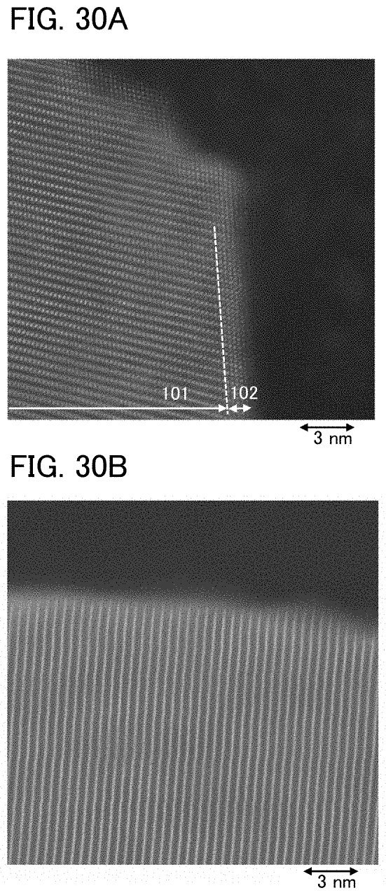

The samples were sliced using a focused ion beam system (FIB) and then HAADF-STEM images thereof were observed. For the observation, JEM-ARM200F manufactured by JEOL Ltd. was used. FIG. 30A shows observed Sample 4, and FIG. 30B shows observed Sample 9.

In FIG. 30A, the second region 102 with a thickness of approximately 1.5 nm was formed on the surface of the particle. It is suggested that the second region 102 and the first region 101 located inward from the second region 102 had different crystal structures and different crystal orientations. In contrast, in FIG. 30B, a layer-like region on the surface of the particle is not clearly observed.

For Sample 4, a layer-like region is formed on the surface, and a relatively high concentration of magnesium was distributed in the region, according to the results of XPS. In contrast, for Sample 9, the concentration of magnesium in the surface of the particle was low, and a clear layer-like region was not observed.

### Example 4

In this example, CR2032 (diameter: 20 mm, height: 3.2 mm) coin type secondary batteries were fabricated using Samples 1 to 8 obtained in Example 1. Their cycle performances were evaluated.

A positive electrode formed by applying slurry in which the fabricated positive electrode active material particles, acetylene black (AB), and polyvinylidene fluoride (PVDF) were mixed at a weight ratio of positive electrode active material particles: AB: PVDF=95:2.5:2.5 to a current collector was used for each positive electrode. Pressing was performed on the positive electrodes of Samples 8 to 10.

A lithium metal was used for each counter electrode.

As an electrolyte contained in each electrolytic solution, 1 mol/L lithium hexafluorophosphate (LiPF₆) was used, and as the electrolytic solution, a solution in which ethylene carbonate (EC) and diethyl carbonate (DEC) at a volume ratio of EC:DEC=3:7 and vinylene carbonate (VC) at a 2 wt % were mixed was used.

Each positive electrode can and each negative electrode can were formed of stainless steel (SUS).

The measurement temperature for the cycle performance test is 25° C. Charge was performed in the following manner: constant current charge was performed at a current density per unit weight of the active material of 68.5 mA/g (at ca. 0.3 C) with an upper limit voltage of 4.6 V, and then, constant voltage charge was performed until the current density reached 1.37 mA/g (at ca. 0.005 C). Discharge was performed in the following manner: constant current discharge was performed at a current density per unit weight of the active material of 68.5 mA/g (at ca. 0.3 C) with a lower limit voltage of 2.5 V. The coin type secondary batteries were each subjected to 30 cycles of charge and discharge.

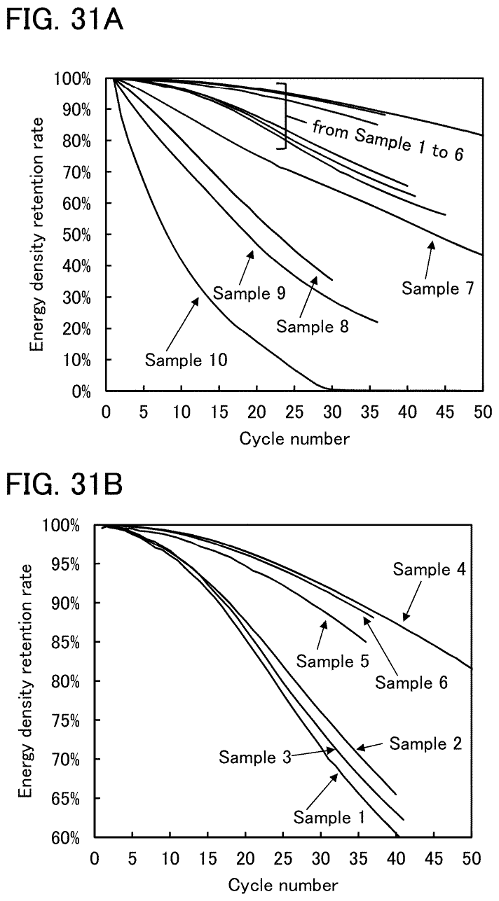

FIG. 31A is a graph showing the cycle performances of the secondary batteries using the positive electrode active material particles of Samples 1 to 8. The horizontal axis represents cycle number, and the vertical axis represents energy density retention rate. Energy density refers to the product of discharge capacity and average discharge voltage. Here, energy density retention rate is expressed assuming that the initial discharge capacity or the maximal discharge capacity is 100%. FIG. 31B is a graph in which the vertical axis is enlarged to clarify the results of Samples 1 to 6.

The capacity retention rate of Sample 4 was higher than those of Samples 1 to 3, and the capacity retention rates of Samples 5 and 6 were higher than the capacity retention rate of Sample 4. The capacity retention rate increased with an increase in the (Li/Co)_R, which is the ratio of starting materials, and a superior capacity retention rate was obtained with a (Li/Co)_R of 1.035 or more. In contrast, the capacity retention rate of Sample 7 with a (Li/Co)_R of higher than 1.05 was lower than those of Samples 1 to 3. The capacity retention rate of Sample 8 was lower than that of Sample 7.

When (Li/Co)_R is set lower than 1.05, a capacity retention rate is increased, and when (Li/Co)_R is set higher than 1.02, a capacity retention rate is further increased.

This application is based on Japanese Patent Application Serial No. 2016-227494 filed with Japan Patent Office on Nov. 24, 2016, the entire contents of which are hereby incorporated by reference.

What is claimed is:

1. A lithium-ion secondary battery, comprising:
a positive electrode; and
a negative electrode,
wherein the positive electrode comprises:
a first region; and
a second region covering at least a part of the first region,
wherein the first region comprises a transition metal and aluminum,
wherein the second region comprises magnesium, and
wherein at least one of the transition metal, the aluminum and the magnesium has a concentration gradient across the first region and the second region.

2. The lithium-ion secondary battery according to claim 1, wherein the transition metal is cobalt.

3. The lithium-ion secondary battery according to claim 2, wherein an atomic ratio of the magnesium to the cobalt measured by X-ray photoelectron spectroscopy is higher than or equal to 0.25 and lower than or equal to 0.3.

4. The lithium-ion secondary battery according to claim 2, wherein an atomic ratio of the lithium to the cobalt measured by X-ray photoelectron spectroscopy is higher than or equal to 0.5 and lower than or equal to 0.85.

5. The lithium-ion secondary battery according to claim 1, wherein a thickness of the second region is greater than or equal to 0.5 nm and less than or equal to 50 nm.

6. The lithium-ion secondary battery according to claim 1,
wherein the positive electrode further comprises a third region comprising at least one of a binder and a conductive additive, and
wherein the second region is between the first region and the third region.

7. An electronic device comprising the lithium-ion secondary battery according to claim 1,
wherein the lithium-ion secondary battery further comprises an electrolyte solution or a solid electrolyte.

8. A lithium-ion secondary battery, comprising:
a positive electrode; and
a negative electrode,
wherein the positive electrode comprises:
a first region; and
a second region covering at least a part of the first region,
wherein the first region comprises a transition metal and aluminum,
wherein the second region comprises fluorine, and
wherein at least one of the transition metal, the aluminum and the fluorine has a concentration gradient across the first region and the second region.

9. The lithium-ion secondary battery according to claim 8, wherein the transition metal is cobalt.

10. The lithium-ion secondary battery according to claim 9, wherein an atomic ratio of the fluorine to the cobalt measured by X-ray photoelectron spectroscopy is higher than or equal to 0.05 and lower than or equal to 0.15.

11. The lithium-ion secondary battery according to claim 9, wherein an atomic ratio of the lithium to the cobalt measured by X-ray photoelectron spectroscopy is higher than or equal to 0.5 and lower than or equal to 0.85.

12. The lithium-ion secondary battery according to claim 8, wherein a thickness of the second region is greater than or equal to 0.5 nm and less than or equal to 50 nm.

13. The lithium-ion secondary battery according to claim 8,
wherein the positive electrode further comprises a third region comprising at least one of a binder and a conductive additive, and
wherein the second region is between the first region and the third region.

14. An electronic device comprising the lithium-ion secondary battery according to claim 8,
wherein the lithium-ion secondary battery further comprises an electrolyte solution or a solid electrolyte.

15. A lithium-ion secondary battery, comprising:
a positive electrode; and
a negative electrode,
wherein the positive electrode comprises:
a first region; and
a second region covering at least a part of the first region,
wherein the first region comprises a transition metal and aluminum,
wherein the second region comprises magnesium and fluorine, and
wherein at least one of the transition metal, the aluminum, the magnesium and the fluorine has a concentration gradient across the first region and the second region.

16. The lithium-ion secondary battery according to claim 15, wherein the transition metal is cobalt.

17. The lithium-ion secondary battery according to claim 16, wherein an atomic ratio of the fluorine to the cobalt measured by X-ray photoelectron spectroscopy is higher than or equal to 0.05 and lower than or equal to 0.15.

18. The lithium-ion secondary battery according to claim 16, wherein an atomic ratio of the magnesium to the cobalt measured by X-ray photoelectron spectroscopy is higher than or equal to 0.25 and lower than or equal to 0.3.

19. The lithium-ion secondary battery according to claim 16, wherein an atomic ratio of the lithium to the cobalt measured by X-ray photoelectron spectroscopy is higher than or equal to 0.5 and lower than or equal to 0.85.

20. The lithium-ion secondary battery according to claim 15, wherein a thickness of the second region is greater than or equal to 0.5 nm and less than or equal to 50 nm.

21. The lithium-ion secondary battery according to claim 15,
wherein the positive electrode further comprises a third region comprising at least one of a binder and a conductive additive, and
wherein the second region is between the first region and the third region.

22. An electronic device comprising the lithium-ion secondary battery according to claim 15,
wherein the lithium-ion secondary battery further comprises an electrolyte solution or a solid electrolyte.
